(19) United States
(12) Patent Application Publication
(10) Pub. No.: US 2026/0303953 A1
(43) Pub. Date: Oct. 1, 2026

(54) IMAGING DEVICE, IMAGING WORK ASSISTANCE METHOD, AND IMAGING WORK ASSISTANCE PROGRAM

(71) Applicant: PANASONIC INTELLECTUAL PROPERTY MANAGEMENT CO., LTD., Osaka (JP)

(72) Inventors: Masayuki YAMAMOTO, Kanagawa (JP); Akihiro FURUTA, Kanagawa (JP)

(73) Assignee: PANASONIC INTELLECTUAL PROPERTY MANAGEMENT CO., LTD., Osaka (JP)

(21) Appl. No.: 19/477,712

(22) PCT Filed: Apr. 24, 2024
(86) PCT No.: PCT/JP2024/016055

§ 371 Date: Oct. 22, 2025

(30) Foreign Application Priority Data
Apr. 28, 2023 (JP) 2023-074916
Apr. 28, 2023 (JP) 2023-074922
Apr. 28, 2023 (JP) 2023-074928
Apr. 28, 2023 (JP) 2023-074934

(51) Int. Cl. H04N 23/63; H04N 23/60; H04N 23/68

(52) U.S. Cl. CPC H04N 23/633; H04N 23/631; H04N 23/64; H04N 23/6812; H04N 23/6815; H04N 23/685

(57) ABSTRACT

Provided is a device that can clearly indicate, to a user conducting imaging work, a point requiring immediate improvement in the imaging work, thereby enabling the user's proper imaging work regardless of their skill level. An imaging device for imaging a measurement target site, thereby allowing a 3D measurement operation to be performed for generating 3D space information on the measurement target site based on captured images thereof, performs operations including: displaying work assistance information regarding imaging work in which a user images the measurement target site while moving therein; determining whether work assistance that improves the user's imaging work is necessary based on states of the captured images (e.g., states regarding blur occurrence, generation of point clouds, and extraction of feature points); and when work assistance is necessary, indicating a warning message that prompts the user to take action for improvement of the user's imaging work.

### TECHNICAL FIELD

The present disclosure relates to an imaging device for imaging spots in a measurement target site, thereby allowing a 3D measurement operation to be performed for generating 3D space information on the measurement target site based on captured images of the spots therein, as well as an imaging work assistance method and an imaging work assistance program for assisting a user to conduct imaging work using the imaging device.

### BACKGROUND ART

Known 3D measurement technologies include a technology that generates 3D space information (map data) related to a measurement target site based on captured images thereof. In the field of 3D measurement technology, SLAM (Simultaneous Localization And Mapping) methods have attracted attention in recent years. In such SLAM methods, a mobile vehicle that carries an imaging device is used, and 3D space information and information on the position of the vehicle are generated as measurement results based on captured images of spots of a measurement target site captured by the imaging device. In some SLAM methods, a user carries a portable imaging device, and conducts imaging work by capturing images with the imaging device while moving around a measurement target site, thereby enabling easy 3D measurements.

In this connection, when a user images a measurement target site while working with holding an imaging device in their hand, work assistance that prompts the user to conduct proper imaging work is desirably provided to the user during the imaging work, so as to enable highly accurate and stable 3D measurement. In view of this need, a known prior art technology presents how to proceed with imaging work to a user by displaying a plurality of symbols such as arrows that indicate a moving direction and moving speed of an imaging device (sensor) held by the user (Patent Document 1).

### PRIOR ART DOCUMENT(S)

### Patent Document(s)

Patent Document 1: JP6489566B

### SUMMARY OF THE INVENTION

### Task to be Accomplished by the Invention

However, since the prior art publication does not provide a user with specific information that enables the user to intuitively grasp how to conduct imaging work, the user needs to determine how the imaging work should be conducted based on the user's past experience by themselves. This resulted in a problem that, when the user does not possess a sufficient level of skill in imaging work for 3D measurement, the imaging work can be conducted in an improper manner. Thus, in the case where imaging work is conducted in such a manner that reduces the accuracy of 3D measurement, it is desirable to clearly indicate to a user a point requiring immediate improvement in the user's imaging work.

The present disclosure has been made in view of the problem of the prior art, and a primary object of the present disclosure is to provide an imaging device, an imaging work assistance method, and an imaging work assistance program that can clearly indicate, to a user conducting imaging work, a point requiring immediate improvement in the imaging work, thereby enabling the user's proper imaging work regardless of their skill level.

### Means To Accomplish The Task

An aspect of the present invention provides an imaging device for imaging a measurement target site, thereby allowing a 3D measurement operation to be performed for generating 3D space information on the measurement target site based on captured images thereof, the imaging device comprising: an imaging device body held by a user; an imaging module provided in the imaging device body to image the measurement target site; a display device for displaying work assistance information regarding imaging work in which the user causes the imaging module to image the measurement target site while moving therein with holding the imaging device body; and a processor for controlling the imaging module and the display device, wherein the processor performs operations including: determining, based on states of the captured images, whether or not work assistance that improves a state of the user's imaging work is necessary; and when determining that work assistance is necessary, displaying work assistance information on the display device, the work assistance information prompting the user to take action for improvement of the user's imaging work.

Another aspect of the present invention provides an imaging work assistance method, wherein a processor performs operations to assist a user to conduct imaging work in which the user causes an imaging device to image a measurement target site while the user is moving therein with holding the imaging device, thereby allowing a 3D measurement operation to be performed for generating 3D space information on the measurement target site based on captured images, wherein the operations performed by the processor include: determining whether or not work assistance that improves the user's imaging work is necessary based on states of the captured images; and when determining that work assistance is necessary, displaying work assistance information on the display device, the work assistance information prompting the user to take action for improvement of the user's imaging work.

Yet another aspect of the present invention provides an imaging work assistance program that causes a processor to perform operations to assist a user to conduct imaging work in which the user causes an imaging device to image a measurement target site while the user is moving therein with holding the imaging device, thereby allowing a 3D measurement operation to be performed for generating 3D space information on the measurement target site based on captured images, wherein the operations performed by the processor include: determining whether or not work assistance that improves the user's imaging work is necessary based on states of the captured images; and when determining that work assistance is necessary, displaying work assistance information on the display device, the work assistance information prompting the user to take action for improvement of the user's imaging work.

### Effect of the Invention

According to the present disclosure, assistance can be provided to a user conducting their imaging work by clearly indicating a point requiring immediate improvement in their imaging work, thereby enabling the user's proper imaging work regardless of their skill level.

### BRIEF DESCRIPTION OF THE DRAWINGS

FIG. 1 is an explanatory diagram showing a state of imaging work using an imaging device in accordance with an embodiment of the present disclosure;

FIG. 2 is an explanatory diagram showing an assistance condition table used in operations performed by a processor;

FIG. 3 is a block diagram showing a schematic configuration of an imaging device;

FIG. 4 is a block diagram showing an overview of operations performed by the processor;

FIG. 5 is an explanatory diagram showing an overlapping region used in a point cloud density evaluation operation and a feature point evaluation operation;

FIG. 6 is a flowchart showing a procedure of operations performed by the processor;

FIG. 7 is a flowchart showing a procedure of operations for assistance condition determination regarding blur, performed by the processor;

FIG. 8 is a flowchart showing a procedure of operations for assistance condition determination regarding point cloud density, performed by the processor;

FIG. 9 is a flowchart showing a procedure of operations for assistance condition determination regarding feature point counts, performed by the processor;

FIG. 10 is a flowchart showing a procedure of operations for assistance condition determination regarding abrupt movement, performed by the processor;

FIG. 11 is a flowchart showing a procedure of operations for assistance condition determination regarding elapsed time, performed by the processor;

FIG. 12 is an explanatory diagram showing an imaging mode screen displayed on a display;

FIG. 13 is an explanatory diagram showing how a warning message is indicated on the imaging mode screen;

FIG. 14 is an explanatory diagram showing how a notice message is indicated on the imaging mode screen;

FIG. 15 is an explanatory diagram showing a setting mode screen displayed on the display; and

FIG. 16 is an explanatory diagram showing how levels of priority are changed on the setting mode screen for item by item.

### DESCRIPTION OF THE PREFERRED EMBODIMENT(S)

As a solution to the above-described task to be accomplished, a first aspect of the present disclosure provides an imaging device for imaging a measurement target site, thereby allowing a 3D measurement operation to be performed for generating 3D space information on the measurement target site based on captured images thereof, the imaging device comprising: an imaging device body held by a user; an imaging module provided in the imaging device body to image the measurement target site; a display device for displaying work assistance information regarding imaging work in which the user causes the imaging module to image the measurement target site while moving therein with holding the imaging device body; and a processor for controlling the imaging module and the display device, wherein the processor performs operations including: determining, based on states of the captured images, whether or not work assistance that improves a state of the user's imaging work is necessary; and when determining that work assistance is necessary, displaying work assistance information on the display device, the work assistance information prompting the user to take action for improvement of the user's imaging work.

According to this configuration, assistance can be provided to a user conducting their imaging work by clearly indicating a point requiring immediate improvement in their imaging work, thereby enabling the user's proper imaging work regardless of their skill level.

A second aspect of the present disclosure is the above-described imaging device, wherein the processor determines whether or not work assistance is necessary based on a state of blur occurrence in the captured images.

This configuration makes it possible to properly determine whether or not work assistance is necessary based on a state of blur occurrence in the captured images, which is affected by a speed at which the user moves the imaging device. This configuration prevents a decrease in 3D measurement accuracy caused by a too-high speed at which the user moves the imaging device.

A third aspect of the present disclosure is the above-described imaging device, wherein the processor determines whether or not work assistance is necessary based on a result of image analysis on the captured images.

This configuration makes it possible to properly determine whether or not work assistance is necessary and what is provided as work assistance by accurately evaluating a state of blur occurrence.

A fourth aspect of the present disclosure is the above-described imaging device, further comprising a detector for detecting a state of motion of the imaging device, wherein the processor determines whether or not work assistance is necessary based on at least one of an exposure time used by the imaging module and a detection result provided from the detector.

This configuration makes it possible to properly determine whether or not work assistance is necessary and what is provided as work assistance by accurately evaluating a state of blur occurrence. Furthermore, blur can be detected (estimated) without using computationally intensive image analysis. In this case, examples of the detector include an IMU (Inertial Measurement Unit). In some cases, the determination may be made based on at least one of an exposure time used by the imaging module and a detection result provided from the detector.

A fifth aspect of the present disclosure is the above-described imaging device, wherein the processor determines whether or not work assistance is necessary based on a state of generation of point clouds generated as measurement results in the 3D measurement operation.

This configuration makes it possible to properly determine whether or not work assistance is necessary based on a state of generation of point clouds, which is affected by a speed at which the user moves the imaging device. This configuration prevents a decrease in 3D measurement accuracy caused by a too-high speed at which the user moves the imaging device. In this case, the determination may be made based on information on point cloud density as the state of generation of point clouds.

A sixth aspect of the present disclosure is the above-described imaging device, wherein the processor determines whether or not work assistance is necessary based on a state of extraction of feature points extracted from the captured images in the 3D measurement operation.

This configuration makes it possible to properly determine whether or not work assistance is necessary based on a state of extraction of feature points, which is affected by a direction to which the user points the imaging device and a speed at which the user moves the imaging device. This configuration prevents a decrease in 3D measurement accuracy caused by an improper direction to which the user turns the imaging device. This configuration prevents a decrease in 3D measurement accuracy caused by a too-high speed at which the user moves the imaging device.

A seventh aspect of the present disclosure is the above-described imaging device, wherein, using a table as a reference, the table containing a plurality of items for each of which a determination condition is entered, the processor determines whether or not work assistance is necessary on an item-by-item basis.

This configuration makes it possible to properly determine whether or not work assistance is necessary for a plurality of items on an item-by-item basis.

An eighth aspect of the present disclosure provides an imaging work assistance method, wherein a processor performs operations to assist a user to conduct imaging work in which the user causes an imaging device to image a measurement target site while the user is moving therein with holding the imaging device, thereby allowing a 3D measurement operation to be performed for generating 3D space information on the measurement target site based on captured images, wherein the operations performed by the processor include: determining whether or not work assistance that improves the user's imaging work is necessary based on states of the captured images; and when determining that work assistance is necessary, displaying work assistance information on the display device, the work assistance information prompting the user to take action for improvement of the user's imaging work.

In this configuration, assistance can be provided to a user conducting their imaging work by clearly indicating a point requiring immediate improvement in their imaging work, thereby enabling the user's proper imaging work regardless of their skill level, in the same manner as the first aspect.

A ninth aspect of the present disclosure provides an imaging work assistance program that causes a processor to perform operations to assist a user to conduct imaging work in which the user causes an imaging device to image a measurement target site while the user is moving therein with holding the imaging device, thereby allowing a 3D measurement operation to be performed for generating 3D space information on the measurement target site based on captured images, wherein the operations performed by the processor include: determining whether or not work assistance that improves the user's imaging work is necessary based on states of the captured images; and when determining that work assistance is necessary, displaying work assistance information on the display device, the work assistance information prompting the user to take action for improvement of the user's imaging work.

In this configuration, assistance can be provided to a user conducting their imaging work by clearly indicating a point requiring immediate improvement in their imaging work, thereby enabling the user's proper imaging work regardless of their skill level, in the same manner as the first aspect.

As a solution to the above-described task to be accomplished, a tenth aspect of the present disclosure provides an imaging device for imaging a measurement target site, thereby allowing a 3D measurement operation to be performed for generating 3D space information on the measurement target site based on captured images thereof, the imaging device comprising: an imaging device body held by a user; an imaging module provided in the imaging device body to image the measurement target site; a display device for displaying work assistance information regarding imaging work in which the user causes the imaging module to image the measurement target site while moving therein with holding the imaging device body; and a processor for controlling the imaging module and the display device, wherein the processor performs operations including: determining, based on a state of the user's imaging work, whether or not work assistance that improves the state of the user's imaging work is necessary; and when determining that work assistance is necessary, displaying work assistance information on the display device, the work assistance information prompting the user to take action for improvement of the user's imaging work.

In this configuration, assistance can be provided to a user conducting their imaging work by clearly indicating a point requiring immediate improvement in their imaging work, thereby enabling the user's proper imaging work regardless of their skill level.

An eleventh aspect of the present disclosure is the imaging device of the tenth aspect, wherein the processor determines whether or not work assistance is necessary based on a degree of abruptness with which the user moves the imaging device.

This configuration makes it possible to properly determine whether or not work assistance is necessary based on a degree of abruptness with which the user moves the imaging device. Thus, this configuration prevents a decrease in 3D measurement accuracy caused by a too-high speed at which the user moves the imaging device. A degree of abruptness of movement refers to a degree of abruptness in the change of a position and orientation of the imaging device, in particular, refers to a degree of acceleration (including deceleration) occurring in the imaging device 1, or a degree of angular speed occurring in the imaging device 1.

A twelfth aspect of the present disclosure is the imaging device of the eleventh aspect, further comprising a detector for detecting a state of motion of the imaging device, wherein the processor determines whether or not work assistance is necessary based on a detection result provided from the detector.

This configuration makes it possible to properly determine whether or not work assistance is necessary based on a state of motion of the imaging device. In this case, examples of the detector include an IMU (Inertial Measurement Unit).

A thirteenth aspect of the present disclosure is the imaging device of the eleventh aspect, wherein the processor determines whether or not work assistance is necessary based on a change in a position and orientation of the imaging device itself acquired in the 3D measurement operation.

This configuration makes it possible to properly determine whether or not work assistance is necessary based on a change in a position and orientation of the imaging device itself, which is affected by a state of motion of the imaging device.

A fourteenth aspect of the present disclosure is the imaging device of the tenth aspect, wherein the processor measures an elapsed time from the start of imaging and determines whether work assistance is necessary based on a result of the measurement.

This configuration provides work assistance regarding elapsed time, thereby preventing a decrease in 3D measurement accuracy caused by a too-long shooting time, which can cause computationally intensive processing operations and accumulation of measurement errors. In some cases, work assistance may be provided when the shooting time approaches an upper limit time, specifically when the shooting time exceeds a threshold value calculated by multiplying the upper limit time by a predetermined ratio.

A fifteenth aspect of the present disclosure is the imaging device of the tenth aspect, wherein the processor measures an elapsed time from the start of imaging and displays information regarding the elapsed time on the imaging work on the display device.

This configuration enables the user to grasp an elapsed time on the imaging work. Example of types of information regarding the elapsed time on the imaging work include an elapsed time from the start of imaging, a remaining time before the upper limit time is reached, and a ratio of the elapsed time from the start to the remaining time before the upper limit time is reached.

A sixteenth aspect of the present disclosure is the imaging device of the tenth aspect, wherein, using a table as a reference, the table containing a plurality of items for each of which a determination condition is entered, the processor determines whether or not work assistance is necessary on an item-by-item basis.

This configuration makes it possible to properly determine whether or not work assistance is necessary for a plurality of items on an item-by-item basis.

A seventeenth aspect of the present disclosure provides an imaging work assistance method, wherein a processor performs operations to assist a user to conduct imaging work in which the user causes an imaging device to image a measurement target site while the user is moving therein with holding the imaging device, thereby allowing a 3D measurement operation to be performed for generating 3D space information on the measurement target site based on captured images, wherein the operations performed by the processor include: determining, based on a state of the user's imaging work, whether or not work assistance that improves the state of the user's imaging work is necessary; and when determining that work assistance is necessary, displaying work assistance information on the display device, the work assistance information prompting the user to take action for improvement of the user's imaging work.

In this configuration, assistance can be provided to a user conducting their imaging work by clearly indicating a point requiring immediate improvement in their imaging work, thereby enabling the user's proper imaging work regardless of their skill level, in the same manner as the tenth aspect.

An eighteenth aspect of the present disclosure provides an imaging work assistance program that causes a processor to perform operations to assist a user to conduct imaging work in which the user causes an imaging device to image a measurement target site while the user is moving therein with holding the imaging device, thereby allowing a 3D measurement operation to be performed for generating 3D space information on the measurement target site based on captured images, wherein the operations performed by the processor include: determining whether or not work assistance that improves the user's imaging work is necessary based on states of the captured images; and when determining that work assistance is necessary, displaying work assistance information on the display device, the work assistance information prompting the user to take action for improvement of the user's imaging work.

In this configuration, assistance can be provided to a user conducting their imaging work by clearly indicating a point requiring immediate improvement in their imaging work, thereby enabling the user's proper imaging work regardless of their skill level, in the same manner as the tenth aspect.

As a solution to the above-described task to be accomplished, a nineteenth aspect of the present disclosure provides an imaging device for imaging a measurement target site, thereby allowing a 3D measurement operation to be performed for generating 3D space information on the measurement target site based on captured images thereof, the imaging device comprising: an imaging device body held by a user; an imaging module provided in the imaging device body to image the measurement target site; a display device for displaying work assistance information regarding imaging work in which the user causes the imaging module to image the measurement target site while moving therein with holding the imaging device body; and a processor for controlling the imaging module and the display device, wherein the processor performs operations including: determining whether or not work assistance that enhances the user's imaging work is necessary; and when determining that work assistance is necessary, displaying work assistance information on the display device, the work assistance information prompting the user to take action for enhancement of the user's imaging work.

In this configuration, when a user's imaging work is good but can be further improved, assistance can be provided to the user conducting their imaging work by clearly indicating a point requiring immediate improvement in their imaging work, thereby enabling the user's proper imaging work regardless of their skill level, in the same manner as the tenth aspect.

A twentieth aspect of the present disclosure is the imaging device of the nineteenth aspect, wherein the operations performed by the processor include: determining whether or not work assistance that improves the inefficient state of the user's imaging work is necessary; and when determining that work assistance is necessary, displaying work assistance information on the display device, the work assistance information prompting the user to take action for promoting efficiency of the user's imaging work.

In this configuration, when a user's imaging work is good but inefficient, assistance can be provided to the user conducting their imaging work by clearly indicating a method for promoting efficiency of the user's imaging work, thereby enabling an increase in the efficiency of the imaging work.

A twenty-first aspect of the present disclosure is the imaging device of the nineteenth aspect, wherein the processor determines whether or not work assistance is necessary based on a state of blur occurrence in the captured images.

This configuration makes it possible to properly determine whether or not work assistance is necessary based on a state of blur occurrence in the captured images, which is affected by a speed at which the user moves the imaging device. This configuration quickly reverses a decrease in the efficiency of imaging work caused by a too-low speed at which the user moves the imaging device, making the user's imaging work more efficient.

A twenty-second aspect of the present disclosure is the imaging device of the twenty-first aspect, wherein the processor determines whether or not work assistance is necessary based on a result of image analysis on the captured images.

This configuration makes it possible to properly determine whether or not work assistance is necessary and what is provided as work assistance by accurately evaluating a state of blur occurrence.

A twenty-third aspect of the present disclosure is the imaging device of the twenty-first aspect, further comprising a detector for detecting a state of motion of the imaging device, wherein the processor determines whether or not work assistance is necessary based on at least one of an exposure time used by the imaging module and a detection result provided from the detector.

This configuration makes it possible to properly determine whether or not work assistance is necessary and what is provided as work assistance by accurately evaluating a state of blur occurrence. Furthermore, blur can be detected (estimated) without using computationally intensive image analysis. In this case, examples of the detector include an IMU (Inertial Measurement Unit). In some cases, the determination may be made based on at least one of an exposure time used by the imaging module and a detection result provided from the detector.

A twenty-fourth aspect of the present disclosure is the imaging device of the nineteenth aspect, wherein the processor determines whether or not work assistance is necessary based on a state of generation of point clouds generated as measurement results in the 3D measurement operation.

This configuration makes it possible to properly determine whether or not work assistance is necessary based on a state of generation of point clouds, which is affected by a speed at which the user moves the imaging device. This configuration quickly reverses a decrease in the efficiency of imaging work caused by a too-low speed at which the user moves the imaging device, making the user's imaging work more efficient.

A twenty-fifth aspect of the present disclosure is the imaging device of the nineteenth aspect, wherein the processor determines whether or not work assistance is necessary based on a state of extraction of feature points extracted from the captured images in the 3D measurement operation.

This configuration makes it possible to properly determine whether or not work assistance is necessary based on a state of extraction of feature points, which is affected by a speed at which the user moves the imaging device. This configuration quickly reverses a decrease in the efficiency of imaging work caused by a too-low speed at which the user moves the imaging device, making the user's imaging work more efficient.

A twenty-sixth aspect of the present disclosure is the imaging device of the nineteenth aspect, wherein the processor determines whether or not work assistance is necessary based on a state of how the user moves the imaging device.

This configuration makes it possible to properly determine whether or not work assistance is necessary based on a state of how the user moves the imaging device. This configuration quickly reverses a decrease in the efficiency of imaging work caused by a too-low speed at which the user moves the imaging device, making the user's imaging work more efficient.

A twenty-seventh aspect of the present disclosure is the imaging device of the nineteenth aspect, wherein, using a table as a reference, the table containing a plurality of items for each of which a determination condition is entered, the processor determines whether or not work assistance is necessary on an item-by-item basis.

This configuration makes it possible to properly determine whether or not work assistance is necessary for a plurality of items on an item-by-item basis.

A twenty-eighth aspect of the present disclosure provides an imaging work assistance method, wherein a processor performs operations to assist a user to conduct imaging work in which the user causes an imaging device to image a measurement target site while the user is moving therein with holding the imaging device, thereby allowing a 3D measurement operation to be performed for generating 3D space information on the measurement target site based on captured images, wherein the operations performed by the processor include: determining whether or not work assistance that enhances the user's imaging work is necessary; and when determining that work assistance is necessary, displaying work assistance information on the display device, the work assistance information prompting the user to take action for enhancement of the user's imaging work.

In this configuration, when a user's imaging work is good but can be further improved, assistance can be provided to the user conducting their imaging work by clearly indicating a point requiring immediate improvement in their imaging work, thereby enabling the user's proper imaging work regardless of their skill level, in the same manner as the tenth aspect, in the same manner as the nineteenth aspect.

A twenty-ninth aspect of the present disclosure provides an imaging work assistance program that causes a processor to perform operations to assist a user to conduct imaging work in which the user causes an imaging device to image a measurement target site while the user is moving therein with holding the imaging device, thereby allowing a 3D measurement operation to be performed for generating 3D space information on the measurement target site based on captured images, wherein the operations performed by the processor include: determining whether or not work assistance that enhances the user's imaging work is necessary; and when determining that work assistance is necessary, displaying work assistance information on the display device, the work assistance information prompting the user to take action for enhancement of the user's imaging work.

In this configuration, when a user's imaging work is good but can be further improved, assistance can be provided to the user conducting their imaging work by clearly indicating a point requiring immediate improvement in their imaging work, thereby enabling the user's proper imaging work regardless of their skill level, in the same manner as the tenth aspect, in the same manner as the nineteenth aspect.

As a solution to the above-described task to be accomplished, a thirtieth aspect of the present disclosure provides an imaging device for imaging a measurement target site, thereby allowing a 3D measurement operation to be performed for generating 3D space information on the measurement target site based on captured images thereof, the imaging device comprising: an imaging device body held by a user; an imaging module provided in the imaging device body to image the measurement target site; a display device for displaying work assistance information regarding imaging work in which the user causes the imaging module to image the measurement target site while moving therein with holding the imaging device body; and a processor for controlling the imaging module and the display device, wherein the processor performs operations including: displaying a customization screen on the display device, the customization screen including an entry section that enables the user to select at least one of a plurality of items, for which subsequent operations are performed, for the at least one item selected by the user through the customization screen, determining whether or not work assistance is necessary and also determining what is provided as work assistance, when determining that work assistance is necessary, performing a work assistance operation that includes displaying work assistance information on the display device.

This configuration enables the user to select items for which work assistance is provided, according to the user's skill level, providing proper work assistance according to the user's skill level or any other factor.

A thirty-first aspect of the present disclosure is the imaging device of the thirtieth aspect, wherein the processor displays the customization screen on the display device, the customization screen including an entry section that enables the user to individually enable or disable operations for the plurality of items on an item-by-item basis, related to the work assistance information that prompts the user to take action for improvement of the user's imaging work.

This configuration allows the user to individually enable or disable operations for the items on an item-by-item basis, related to the work assistance information (e.g., warning message) that prompts the user to take action for improvement of the user's imaging work. In this case, the entry section may be formed e.g., by checkboxes on the screen.

A thirty-second aspect of the present disclosure is the imaging device of the thirtieth aspect, wherein the processor displays the customization screen on the display device, the customization screen including an entry section that enables the user to individually enable or disable operations for the plurality of items on an item-by-item basis, related to the work assistance information that prompts the user to take action for enhancement of the user's imaging work.

This configuration allows the user to individually enable or disable operations for the items on an item-by-item basis, related to the work assistance information (e.g., notice message) that prompts the user to take action for enhancement of the user's imaging work. In this case, the entry section may be formed e.g., by checkboxes.

A thirty-third aspect of the present disclosure is the imaging device of the thirtieth aspect, wherein the processor displays the customization screen on the display device, the customization screen including an entry section that enables the user to instruct the imaging device to store setting information acquired through the user's operation on the customization screen, and read the stored setting information.

This configuration enables the user to instruct the imaging device to store setting information, and read the stored setting information, thereby facilitating operations for settings when the imaging work starts.

A thirty-fourth aspect of the present disclosure is the imaging device of the thirtieth aspect, wherein the processor displays the customization screen on the display device, the customization screen including an entry section that enables the user to enter a determination condition that can be used to determine whether or not work assistance to the user is necessary.

This configuration enables the user to enter a determination condition that can be used to determine whether or not work assistance to the user is necessary. In this case, the entry section for entry of determination conditions may be formed as e.g., entry fields for entry of threshold values as determination conditions to determine whether or not work assistance to the user is necessary. In other cases, the entry section for entry of determination conditions may be used to adjust the levels of determination conditions.

A thirty-fifth aspect of the present disclosure is the imaging device of the thirtieth aspect, wherein the processor displays the customization screen on the display device, the customization screen including an entry section that enables the user to designate levels of priority with which the work assistance operations are performed, for the plurality of items on an item-by-item basis, based on determination results indicating the necessity of work assistance for the plurality of items.

This configuration enables the user to designate levels of priority with which the work assistance operations are performed, for the items on an item-by-item basis. In this case, the levels of priority may be changed e.g., by rearranging the order of indicators for the items by drag-and-drop actions.

A thirty-sixth aspect of the present disclosure provides an imaging work assistance method, wherein a processor performs operations to assist a user to conduct imaging work in which the user causes an imaging device to image a measurement target site while the user is moving therein with holding the imaging device, thereby allowing a 3D measurement operation to be performed for generating 3D space information on the measurement target site based on captured images, wherein the operations performed by the processor include: displaying a customization screen on the display device, the customization screen including an entry section that enables the user to select at least one of a plurality of items, for which subsequent operations are performed, for the at least one item selected by the user through the customization screen, determining whether or not work assistance is necessary and also determining what is provided as work assistance, when determining that work assistance is necessary, performing a work assistance operation that includes displaying work assistance information on the display device.

This configuration enables the user to select items for which work assistance is provided, according to the user's skill level, providing proper work assistance according to the user's skill level or any other factor, in the same manner as the thirtieth aspect.

A thirty-seventh aspect of the present disclosure provides an imaging work assistance program that causes a processor to perform operations to assist a user to conduct imaging work in which the user causes an imaging device to image a measurement target site while the user is moving therein with holding the imaging device, thereby allowing a 3D measurement operation to be performed for generating 3D space information on the measurement target site based on captured images, wherein the operations performed by the processor include: displaying a customization screen on the display device, the customization screen including an entry section that enables the user to select at least one of a plurality of items, for which subsequent operations are performed, for the at least one item selected by the user through the customization screen, determining whether or not work assistance is necessary and also determining what is provided as work assistance, when determining that work assistance is necessary, performing a work assistance operation that includes displaying work assistance information on the display device.

This configuration enables the user to select items for which work assistance is provided, according to the user's skill level, providing proper work assistance according to the user's skill level or any other factor, in the same manner as the thirtieth aspect.

Embodiments of the present disclosure will be described below with reference to the drawings.

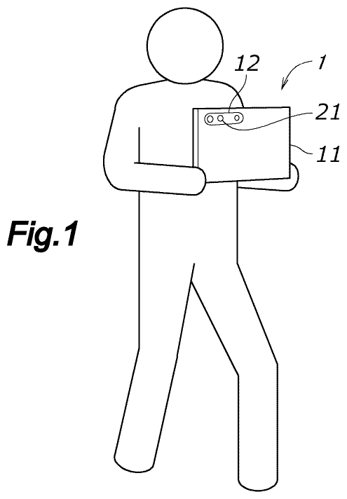

FIG. 1 is an explanatory diagram showing a state of imaging work which a user performs using an imaging device 1 in accordance with an embodiment of the present disclosure.

The imaging device 1 includes an imaging device body 11 and a sensor device 12. The sensor device 12 is equipped with a visible ray camera 21 (imaging module). The visible ray camera 21 is a monocular camera that detects visible light to capture an image of a subject, and outputs captured images, such as RGB color images. In addition, the imaging device 1 may be configured with a tablet terminal or a laptop PC.

A user (worker) walks around a measurement target site while holding the imaging device body 11 of the imaging device 1. The visible ray camera 21 of the imaging device 1 is caused to capture images of spots in the measurement target site on a spot-by-spot basis.

In the present embodiment, the imaging device 1 is a 3D measurement device. In other words, the imaging device 1 performs 3D measurement operations based on the images of the spots captured by the visible ray camera 21 on a spot-by-spot basis, to thereby generate 3D space information on the measurement target site. The 3D measurement operations are performed to generate point cloud image data (environmental map) as 3D space information on the measurement target site using an SLAM method.

In the embodiment shown in FIG. 1, captured image data is acquired by a user holding the imaging device body 11 while walking around the measurement target site. In other embodiments, captured image data may be acquired by using a self-propelled mobile robot equipped with the imaging device 1 that moves around the measurement target site. When a self-propelled mobile robot performs imaging work, work assistance is provided to a user manipulating the robot.

In the present embodiment, the imaging device 1 equipped with the sensor device 12, such as the visible ray camera 21, performs the 3D measurement operation. However, in some cases, the sensor device 12 may be configured as an imaging device 1 separated from a PC (information processing device) that performs the 3D measurement operation.

A user captures images of the measurement target site with the imaging device 1 in their hand while walking around the measurement target site. Thus, imaging work includes actions such as walking (moving) with holding the imaging device 1 and pointing the imaging device 1 to an appropriate direction.

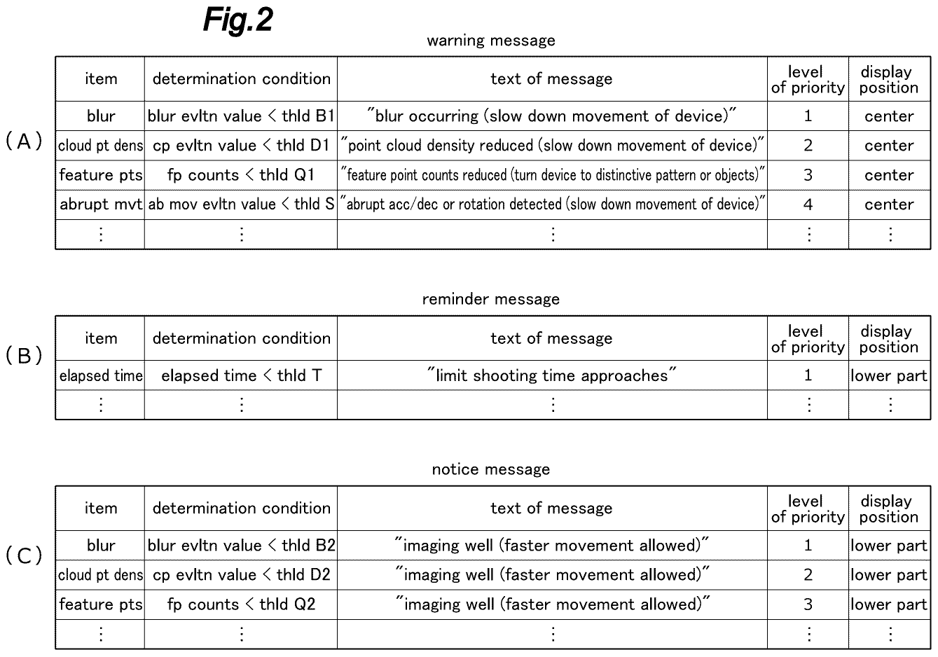

Next, an overview of processing operations performed by a processor 16 will be described. FIG. 2 is an explanatory diagram showing an assistance condition table used in operations performed by the processor 16.

In the present embodiment, messages (work assistance information) are displayed on a screen of the imaging device 1 as a work assistance measure. The messages include warning messages, reminder messages, and notice messages. The warning messages prompt the user to take action to improve a state of the user's imaging work that requires immediate improvement. The reminder messages alert the user to specific matters. The notice messages prompt the user to take action to improve a state of the user's imaging work that, while not requiring immediate improvement, has room for enhancement (e.g., action to promote efficiency of the imaging work).

In the present embodiment, using the assistance condition table as a reference, the processor determines, based on the evaluation value for each of items (such as blur, point cloud density, feature point counts, abrupt movement, elapsed time), whether or not work assistance is necessary and what is provided as work assistance for each item (assistance condition determination operation). The assistance condition table contains entered thresholds for each item as determination criteria, and the processor compares the evaluation value of each item with a corresponding threshold to determine whether or not work assistance is necessary and what is provided as work assistance for each item.

As shown in FIG. 2(A), the assistance condition table contains, for each of the items (e.g., blur, point cloud density, feature point counts, and abrupt movement), the determination condition for determining whether a warning message as work assistance is necessary, and the text of a message to be displayed on the screen.

When the user moves the imaging device 1 too quickly while shooting, blur (bokeh) occurs in a captured image from the visible ray camera 21, which reduces the accuracy of point cloud image data. In the present embodiment, the processor calculates an evaluation value (blur evaluation value) representing the occurrence of blur in the captured image, and based on this blur evaluation value, detects a state in which the user is moving the imaging device 1 too quickly. In this case, as a work assistance measure, the processor displays a warning message on the screen prompting the user to slow down the movement of the imaging device 1.

Specifically, the blur evaluation value is defined such that a smaller value indicates stronger blur. A threshold B1 is set for the blur evaluation value, and when the blur evaluation value falls below the threshold B1 (blur evaluation value <threshold B1), the processor determines that the user is moving the imaging device 1 too quickly. In this case, the processor displays a warning message (e.g., “blur occurring (slow down movement of device)”) on the screen prompting the user to slow down the movement of the imaging device 1.

When the user moves the imaging device 1 too quickly while shooting, a point cloud is created with insufficient density, resulting in a reduced accuracy of the point cloud image data. In the present embodiment, the processor calculates an evaluation value (point cloud density evaluation value) representing a state of generation of point clouds, and based on the point cloud density evaluation value, detects a state in which the user is moving the imaging device 1 too quickly. In this case, as a work assistance measure, the processor displays a warning message on the screen prompting the user to slow down the movement of the imaging device 1.

Specifically, the point cloud density evaluation value is defined such that a smaller value indicates lower point cloud density. A threshold D1 is set for the point cloud density evaluation value, and when the point cloud density evaluation value falls below the threshold D1 (point cloud density evaluation value<threshold D1), the processor determines that the user is moving the imaging device 1 too quickly. In this case, the processor displays a warning message (e.g., “point cloud density reduced (slow down movement of device)”) on the screen prompting the user to slow down the movement of the imaging device 1. Furthermore, the point cloud density can sometimes be increased by repeatedly shooting the same place. Thus, the processor may calculate the point cloud density evaluation value based solely on newly generated point clouds, or calculate it based on both newly generated point clouds and previously generated point clouds.

Shooting a place containing a large amount of regions with few distinctive patterns or objects (such as walls, floors, and ceilings), is likely to lead to unsuccessful extraction of feature point and thus decreased extracted feature points, which reduces the accuracy of point cloud image data. In the present embodiment, the processor calculates an evaluation value (value of feature point counts) representing the state of extraction of feature point in the captured image, and based on the value of feature point counts, detects a state in which the user turns the imaging device 1 to an improper direction. In this case, as a work assistance measure, the processor displays a warning message on the screen prompting the user to turn the imaging device 1 to a proper direction.

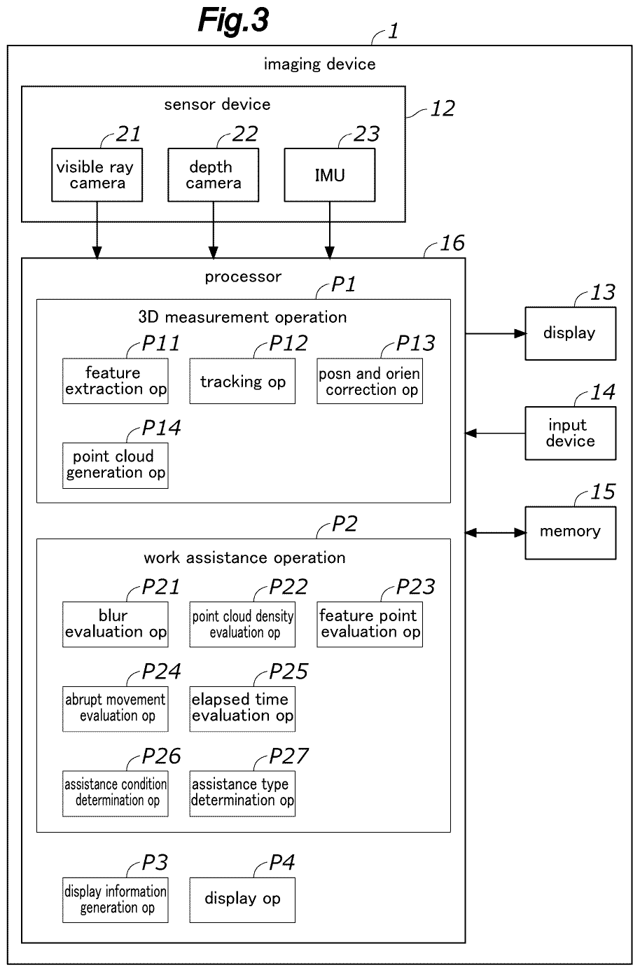

Specifically, a threshold Q1 is set for the value of feature point counts, and when the value of feature point counts falls below the threshold Q1 (value of feature point counts<threshold Q1), the processor determines that the user turns the imaging device 1 to an improper direction. In this case, the processor displays a warning message (e.g., “feature point counts reduced (turn device to distinctive pattern or objects)”) on the screen prompting the user to turn the imaging device 1 to a proper direction. In some cases, displayed on the screen may be a warning message “feature point counts reduced (turn device to region with less walls and floors).” When an IMU 23 (FIG. 3) can operate normally, a tracking operation for tracking position and orientation of the imaging device is less likely to fail because corrections are made to the position and orientation information based on detection data from the IMU 23. Thus, even when captured images contain less distinctive features, such as walls, floors, or ceilings, the tracking operation can sometimes continue with minimal error. When the user moves the imaging device 1 too quickly during shooting, causing the imaging device 1 to move to an extent that does not allow the IMU 23 to operate normally, the tracking operation is more likely to fail.

Thus, when the value of feature point counts falls below the threshold Q1, the processor determines that the user's quick movement of the imaging device 1 can make the tracking operation prone to failure, and display a warning message (e.g., “feature point counts reduced (slow down movement of device)” on the screen prompting the user to slow down the movement of the imaging device 1. This allows the user to slow down the movement of the imaging device 1 so that the IMU 23 can operate normally, thereby stabilizing generation of point clouds.

As described above, when the user moves the imaging device 1 too quickly while shooting, the reduced accuracy of point cloud image data can be detected based on states regarding blur, point cloud density, and feature points. In addition, the user's movement of the imaging device causes the acceleration and angular velocity to be generated in the imaging device itself, and thus the processor can detect a state in which the user is moving the imaging device 1 too quickly based on the acceleration and angular velocity generated within the imaging device 1.

In the present embodiment, the processor detects an abrupt acceleration or deceleration state or an abrupt rotation state as a user's abrupt movement, where the former state is when the acceleration generated in the imaging device 1 falls outside a predetermined range, and the latter state is when the angular velocity generated in the imaging device 1 falls outside a predetermined range. When the user performs an abrupt movement, the processor displays a warning message on the screen prompting the user to slow down the speed at which the user moves the imaging device 1 as a work assistance measure.

Specifically, the abrupt movement evaluation value (an indicator based on detection data from the IMU 23) is defined such that a large value indicates more abrupt movement. A threshold S is set for the abrupt movement evaluation value, and when the abrupt movement evaluation value exceeds the threshold S (abrupt movement evaluation value >threshold S), the processor determines that the user is moving imaging device 1 too quickly. In this case, the processor displays a warning message such as “abrupt acceleration/deceleration or rotation detected (slow down movement of device)” on the screen prompting the user to slow down the movement of the imaging device 1.

As shown in FIG. 2(B), the assistance condition table contains, for each of the items (e.g., elapsed time), the determination condition for determining whether a reminder message as work assistance is necessary, and the text of a message to be displayed on the screen.

When the shooting time (i.e. elapsed time) is too long, computationally intensive processing operations and accumulation of measurement errors cause a decrease in the accuracy of point cloud image data. In the present embodiment, an upper limit time is set for shooting time, and when the shooting time approaches the upper limit time, the processor displays a reminder message to alert the user on the screen as a work assistance measure.

Specifically, a threshold T is set for the elapsed time. When the elapsed time exceeds the threshold T (elapsed time>threshold T), the processor displays a reminder message (e.g., “limit shooting time approaches”) on the screen. The threshold T may be calculated by multiplying the upper limit time by a predetermined ratio (e.g., 90%).

As shown in FIG. 2(C), the assistance condition table contains, for each of the items (e.g., blur, point cloud density, feature point counts), the determination condition for determining whether a notice message as work assistance is necessary, and the text of a message to be displayed on the screen.

When the user moves the imaging device 1 too quickly while shooting, the efficiency of imaging work decreases. In the present embodiment, the processor detects a state in which the user moves the imaging device 1 too slowly or a state in which the user does not need to slow down the movement, based on the blur evaluation value, point cloud density evaluation value, and value of feature point counts. When the user is moving the imaging device 1 too slowly, or when there is no need for the user to slow down the movement, the processor displays a notice message on the screen prompting the user to move the imaging device 1 faster as a work assistance measure.

Specifically, a threshold B2 is set for the blur evaluation value. When the blur evaluation value exceeds the threshold B2 (blur evaluation value>threshold B2), the processor determines that the user is moving the imaging device 1 too slowly. A threshold D2 is set for the point cloud density evaluation value. When the point cloud density evaluation value exceeds the threshold D2 (point cloud density evaluation value>threshold D2), the processor determines that the user is moving imaging device 1 too slowly. Furthermore, a threshold Q2 is set for the value of feature point counts. When the value of feature point counts exceeds the threshold Q2 (value of feature point counts>threshold Q2), the processor determines that the user does not need to slow down the movement of the imaging device 1. In this way, when determining that the user is moving the imaging device 1 too slowly or the user does not need to slow down the movement of the imaging device 1, the processor displays a notice message, such as “shooting well (faster movement allowed)” on the screen, prompting the user to move the imaging device 1 faster.

In the present embodiment, using the assistance condition table as a reference, the processor selects, based on the priority (priority order) of each of items, one or more items for which work assistance is to be provided from among the items for which work assistance is determined to be necessary, and then determines, for each item, what is provided as work assistance; that is, a message (warning message, reminder message, or notice message) to be displayed on the screen (assistance type determination operation).

As shown in FIG. 2(A), (B), and (C), the assistance condition table contains levels of priority of messages used when displayed. When determining that work assistance is required for a plurality of items, the processor provides work assistance only for the items with high priority. In this case, the processor may select only one item with the highest priority, or select a predetermined number of items in descending order of the level of priority.

In the case where no priority is set, when determining that work assistance is required for a plurality of items, the processor may provide work assistance (display a message) for all of those items. In some cases, when determining that work assistance is required for a plurality of items, the processor may provide work assistance for all of those items, and displaying the messages on the display with arranging the displayed messages in descending order of the level of priority from top to bottom.

The assistance condition table contains the display position of each of the warning messages, reminder messages, and notice messages on the screen, the display position being set for each of the items.

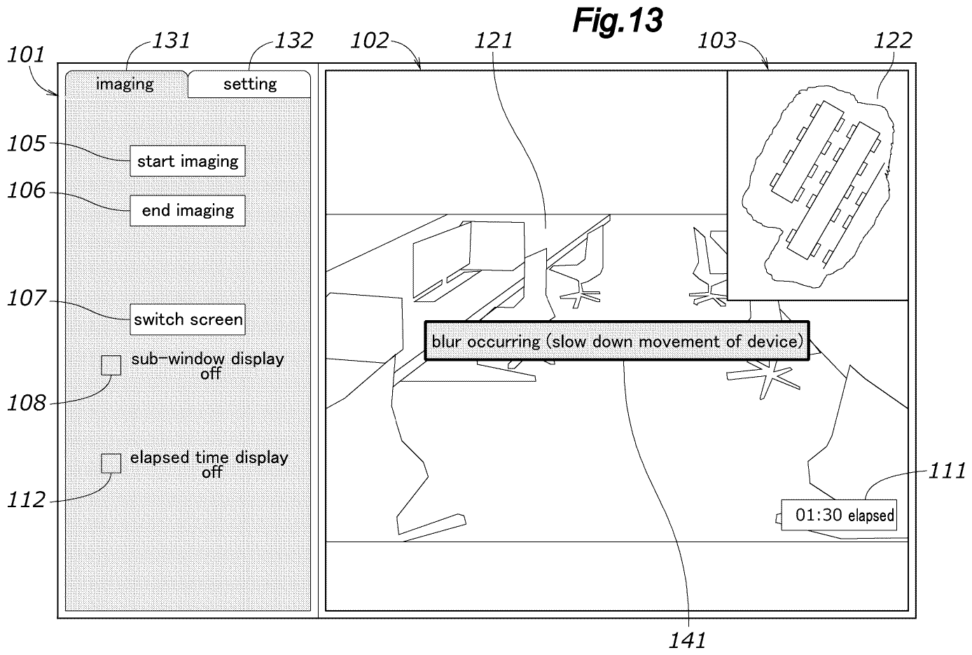

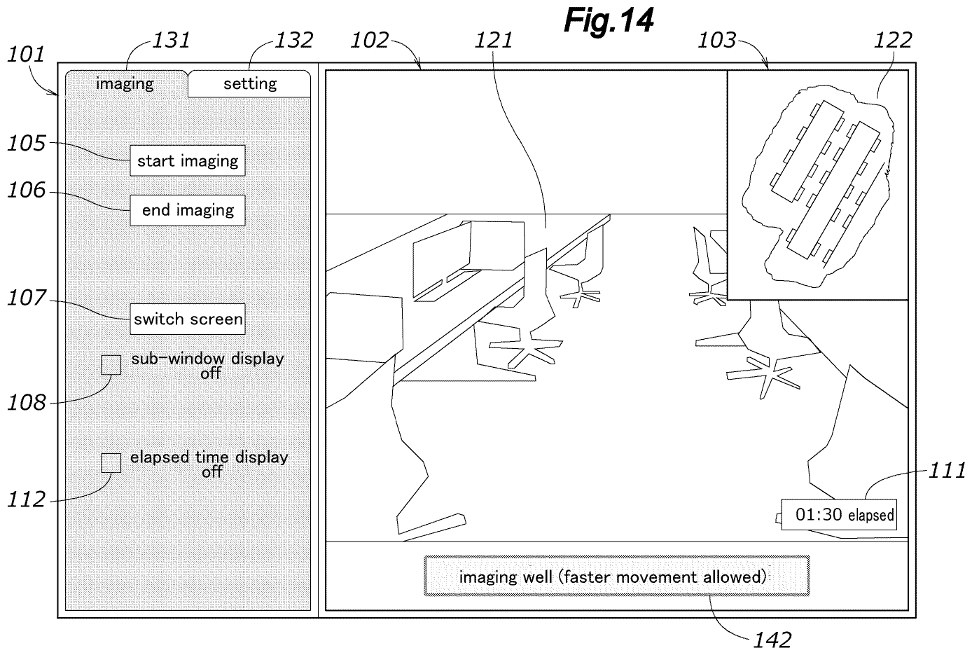

The warning messages are displayed in the center of the screen (FIG. 13). In this example, the warning messages regarding blur, point cloud density, feature point counts, and abrupt movement are displayed in the center of the screen. The notice messages and reminder messages are displayed at the bottom of the screen (FIG. 14). In this example, the notice messages regarding blur, point cloud density, and feature point counts, along with a reminder message regarding elapsed time, are displayed at the bottom of the screen.

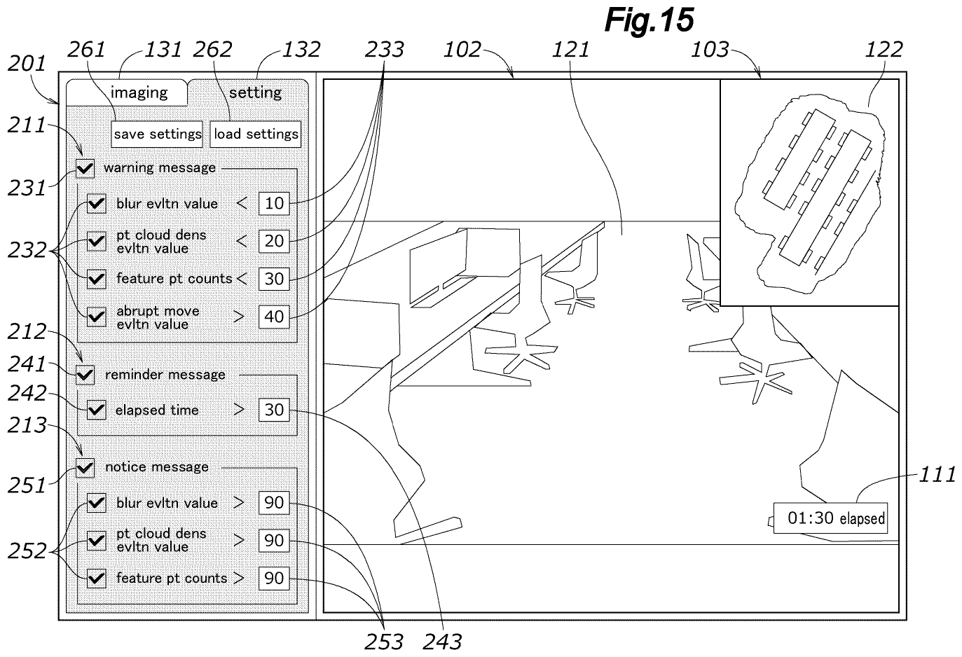

In the assistance condition table, the threshold values and levels of priority may be fixed values. However, in the present embodiment, the user is allowed to enter the threshold values and levels of priority on a setting mode screen (FIG. 15).

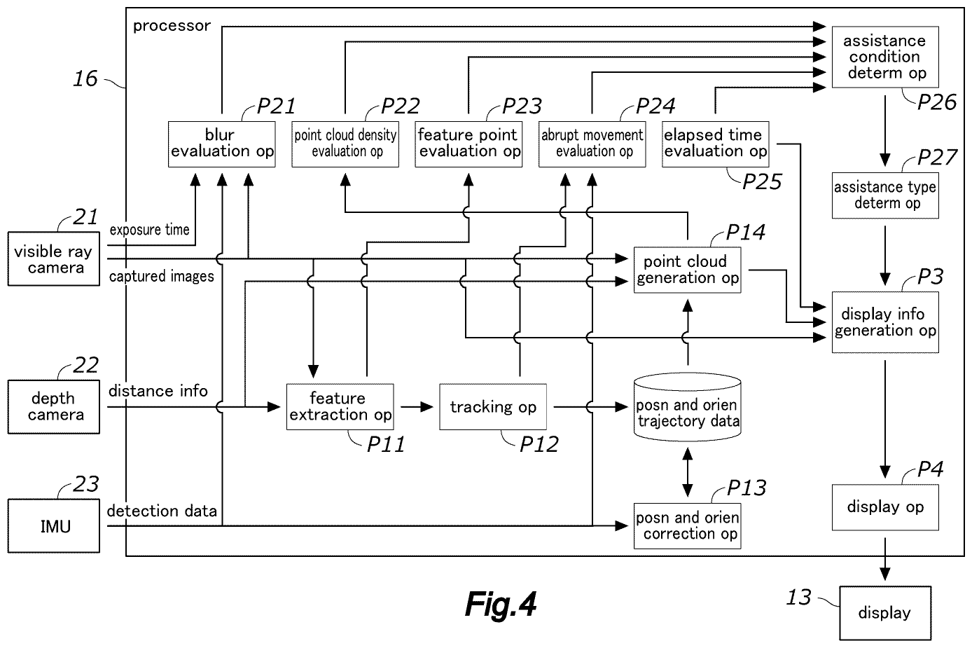

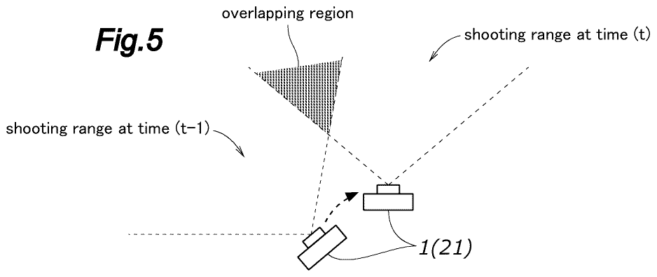

Next, a schematic configuration of the imaging device 1 will be described. FIG. 3 is a block diagram showing a schematic configuration of the imaging device 1. FIG. 4 is a block diagram showing an overview of operations performed by the processor 16. FIG. 5 is an explanatory diagram showing an overlapping region used in a point cloud density evaluation operation and a feature point evaluation operation.

As shown in FIG. 3, the imaging device 1 includes, in addition to the sensor device 12, a display 13 (display device), an input device 14, a memory 15 (storage), and the processor 16 (CPU).

The sensor device 12 includes, in addition to the visible ray camera 21, a depth camera 22 and an IMU 23 (Inertial Measurement Unit).

The depth camera 22 is a stereo camera that detects infrared light to capture images of a subject, and outputs depth information (distance images) as results of the detection. The results of the detection output from the depth camera 22 can be used to measure the distance to the subject. In addition to a stereo camera, any other type of camera capable of acquiring depth information, such as LiDAR, may be used as the depth camera 22 as well.

The IMU 23 (detector) detects states of motion of the imaging device 1; specifically, it detects 3D angular velocity and acceleration. Results of the detection from the IMU 23 can be used to measure the amounts of movement and rotation of the imaging device 1.

In some embodiments, the visible ray camera 21, depth camera 22, and IMU 23 may not be integrated into a single sensor unit. In other embodiments, the sensor device 12 may be configured to include only the visible ray camera 21, without the depth camera 22 and IMU 23. Alternatively, the sensor device 12 may include one of the depth camera 22 and IMU 23 and the visible ray camera 21.

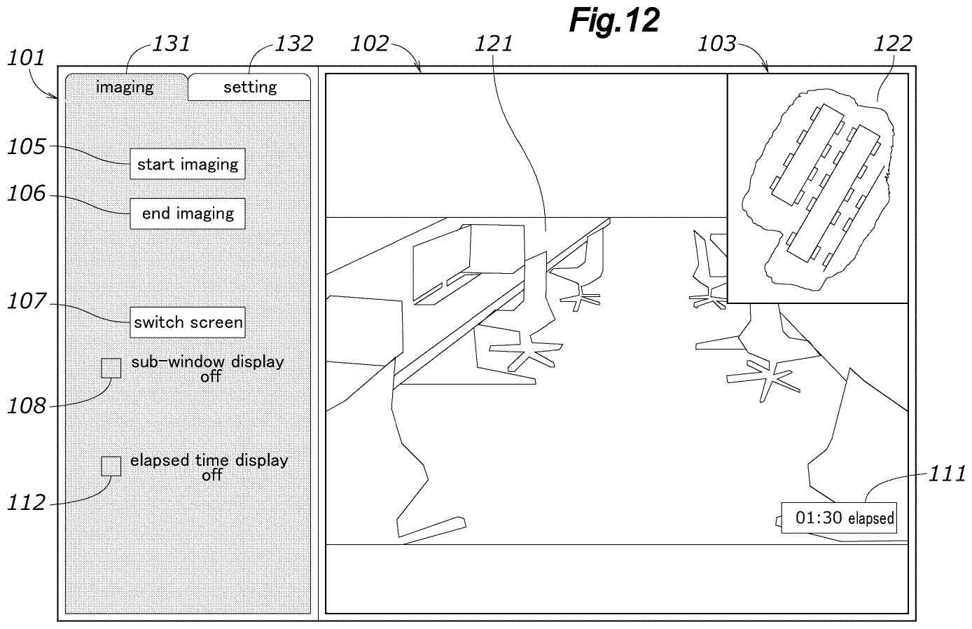

The display 13 displays screens that present to a user various types of information related to the imaging work, such as an imaging mode screen 101 (FIG. 12) and a setting mode screen 201 (FIG. 15).

The input device 14 is used by a user to perform input operations. The input device 14 may include a keyboard, a mouse, a touch pad, and a touch screen. The imaging device 1 which is implemented as a tablet includes a touch screen display consisting primarily of both a touch screen as the input device 14 and a display panel as the display 13.

The memory 15 stores computer-readable programs that are executable by a processor 16. The memory 15 also stores captured images provided from the visible ray camera 21, distance information provided from the depth camera 22, and detection result data provided from the IMU 23. The memory 15 further stores measurement results (point cloud image data) generated by the processor 16.

The processor 16 performs various processing operations by executing the programs stored in the memory 15. In the present embodiment, the processor 16 performs operations such as a 3D measurement operation P1, a work assistance operation P2, a display information generation operation P3, and a display operation P4.

The 3D measurement operation P1 includes a feature extraction operation P11, a tracking operation P12, a position and orientation correction operation P13, and a point cloud generation operation P14.

The work assistance operation P2 includes a blur evaluation operation P21, a point cloud density evaluation operation P22, a feature point evaluation operation P23, an abrupt movement evaluation operation P24, an elapsed time evaluation operation P25, an assistance condition determination operation P26, and an assistance type determination operation P27.

In the present embodiment, the imaging device 1 performs the 3D measurement operation P1, work assistance operation P2, and display information generation operation P3. However, in other embodiment, all or some of these operations may be performed by a server device (not shown) capable of communicating with the imaging device 1.

As shown in FIG. 4, in the feature extraction operation P11, the processor 16 extracts feature information (such as feature point counts) from the captured images (frames) provided from the visible ray camera 21.

In the tracking operation P12, the processor 16 compares currently extracted feature points with previously extracted feature points to estimate an amount of displacement regarding the position and orientation of the imaging device 1, and then updates the position and orientation trajectory data based on the estimated amount of displacement. The position and orientation trajectory data is data obtained by tracking the position and orientation of the imaging device 1 and includes the tracking results for the position and orientation at the times each of which is a time an image (frame) was captured (i.e., information regarding the position and orientation of the imaging device 1 at each shooting time).

In the position and orientation correction operation P13, the processor 16 corrects the position and orientation trajectory data acquired in the tracking operation P12 based on the detection data provided from the IMU 23. In this operation, the position and orientation trajectory data is corrected to supplement the measurement results from regions with few distinctive features, such as walls or ceilings.

In the point cloud generation operation P14, the processor 16 generates point cloud image data based on distance information provided from the depth camera 22, and the position and orientation trajectory data acquired in the tracking operation P12 and the position and orientation correction operation P13.

In the blur evaluation operation P21, the processor 16 acquires, through image analysis of the captured images, an evaluation value (blur evaluation value) representing a state of blur occurrence in the captured images. The blur evaluation value evaluates the occurrence of blur in the captured images, and a smaller value indicates stronger blur. The image analysis performed in the blur evaluation operation P21 may employ various known techniques, such as evaluation of blur occurrence based on edges contained within the captured images.

In another type of the blur evaluation operation P21, the processor 16 acquires an evaluation value (blur evaluation value) representing a state of blur occurrence in the captured images based on the exposure time of the visible ray camera 21 and the detection data (acceleration, angular velocity) provided from the IMU 23. A longer exposure time indicates a higher likelihood of occurrence of strong blur, and a larger detected acceleration or angular velocity of the imaging device 1 also indicates a higher likelihood of occurrence of strong blur. Thus, the state of blur occurrence can be estimated based on the exposure time of the visible ray camera 21 and the detection data (acceleration, angular velocity) provided from the IMU 23.

The blur evaluation operation P21 may be performed based solely on one of the exposure time of the visible ray camera 21 and the detection data from the IMU 23. While the exposure time of the visible ray camera 21 itself is not closely related to the user's imaging work, the influence of a state of motion of the imaging device 1 on blur occurrence varies depending on the length of the exposure time. For example, with a long exposure time, when the acceleration and angular velocity of the imaging device 1 are not sufficiently small, significant blur occurs. Conversely, with a short exposure time, even when the acceleration and angular velocity of the imaging device 1 are somewhat large, significant blur does not occur.

In the point cloud density evaluation operation P22, the processor 16 counts point clouds within a target area based on the point cloud image data generated in the point cloud generation operation P14, thereby acquiring an evaluation value (point cloud density evaluation value) representing a state of generation of point clouds. The point cloud density evaluation value indicates whether real-time point cloud generation is being performed in a proper manner. A smaller point cloud density evaluation value indicates a lower point cloud density.

The point cloud density evaluation value may be calculated based on the number of point clouds generated within a predetermined unit time (e.g., one second) and the size of a shooting range of the visible ray camera 21, as the following formula:

Point cloud density evaluation value=(Number of point clouds generated per unit time)/(Field of view).

In this case, when a small number of point clouds are generated across the entire field of view of the visible ray camera 21, the point cloud density evaluation value becomes smaller.

The point cloud density evaluation value may also be the number of generation of point clouds in an overlapping region (total number of point clouds within an overlapping region), which is the common region between the shooting range at the current shooting time t and the shooting range at the previous shooting time t−1 (FIG. 5). In this case as well, a smaller point cloud density evaluation value indicates a lower point cloud density. The point cloud density evaluation value becomes small not only when fewer point clouds are generated within the shooting range of the visible ray camera 21, but also when an overlapping region is narrower between the shooting range at the current shooting time t and the shooting range at the previous shooting time t−1. The point cloud density can sometimes be increased by repeatedly shooting the same place. Thus, the processor may calculate the point cloud density evaluation value based solely on newly generated point clouds, or calculate it based on both newly generated point clouds and previously generated point clouds. In this case, the number of generation of point clouds represents the total number of all point clouds contained within the overlapping region, not only the point clouds generated at the current shooting time t.

In the feature point evaluation operation P23, the processor 16 counts point clouds within a target area based on extraction results in the feature extraction operation P11, thereby acquiring an evaluation value (value of feature point counts) representing a state of extraction of feature points.

The value of feature point counts may be the number of feature points extracted from a single captured image (one frame). The value of feature point counts may also be the number of feature points extracted from an overlapping region (FIG. 5) between the shooting range at the current shooting time t and the shooting range at the previous shooting time t−1.

In the abrupt movement evaluation operation P24, the processor 16 acquires an evaluation value (abrupt movement evaluation value) representing a degree of abruptness of the user's movement of the imaging device 1, based on the detection data (acceleration, angular velocity) provided from the IMU 23. The degree of abruptness represents the abruptness of change in the device's position and orientation, specifically representing the magnitude of acceleration (including deceleration) occurring in the imaging device 1 or the magnitude of angular velocity occurring in the imaging device 1.

In another type of the abrupt movement evaluation operation P24, the processor 16 acquires an abrupt movement evaluation value based on an amount of displacement regarding the position and orientation of the imaging device 1 acquired in the tracking operation P12. The amount of displacement represents a state of change in the position and orientation of the imaging device 1, and the abruptness of movement can be evaluated based on the magnitude of the amount of displacement.

In the elapsed time evaluation operation P25, the processor 16 measures an elapsed time from the start of imaging and acquires an evaluation value (elapsed time) representing an elapsed time on the imaging work. Specifically, when shooting starts, the processor starts measuring time using a timer and acquires the measured time from the timer at the measurement time point as the elapsed time.

In the assistance condition determination operation P26, using the assistance condition table (FIG. 2) as a reference, the processor 16 determines, based on the evaluation value for each of items (such as blur, point cloud density, feature point counts, abrupt movement, elapsed time), whether or not work assistance is necessary and what is provided as work assistance for each item. The assistance condition table contains entered thresholds for each item as determination criteria, and the processor compares the evaluation value of each item with a corresponding threshold in this operation.

In the assistance type determination operation P27, using the assistance condition table as a reference (FIG. 2), the processor 16 selects, based on the priority of each of items, one or more items for which work assistance is to be provided from among the items for which work assistance is determined to be necessary, and then determines, for each item, what is provided as work assistance; that is, a message (warning message, reminder message, or notice message) to be displayed on the screen.

In the display information generation operation P3, the processor 16 generates display information for a screen to be displayed on the display 13, based on (i) the captured images provided from the visible ray camera 21, (ii) point cloud image data generated in the point cloud generation operation P14, and (iii) elapsed time acquired in the elapsed time evaluation operation P25. In the display information generation operation P3, the processor 16 generates display information for a screen that includes what is provided as work assistance (warning message, reminder message, notice message) determined in the assistance type determination operation P27 when work assistance is required.

In the display operation P4, the processor 16 displays screens (FIGS. 12 to 15) on the display 13 based on the display information generated in the display information generation operation P3.

In the present embodiment, the operations performed to acquire the evaluation value for determining whether work assistance is necessary include a blur evaluation operation P21, a point cloud density evaluation operation P22, a feature point evaluation operation P23, an abrupt movement evaluation operation P24, and an elapsed time evaluation operation P25; however, only some of these operations may be performed.

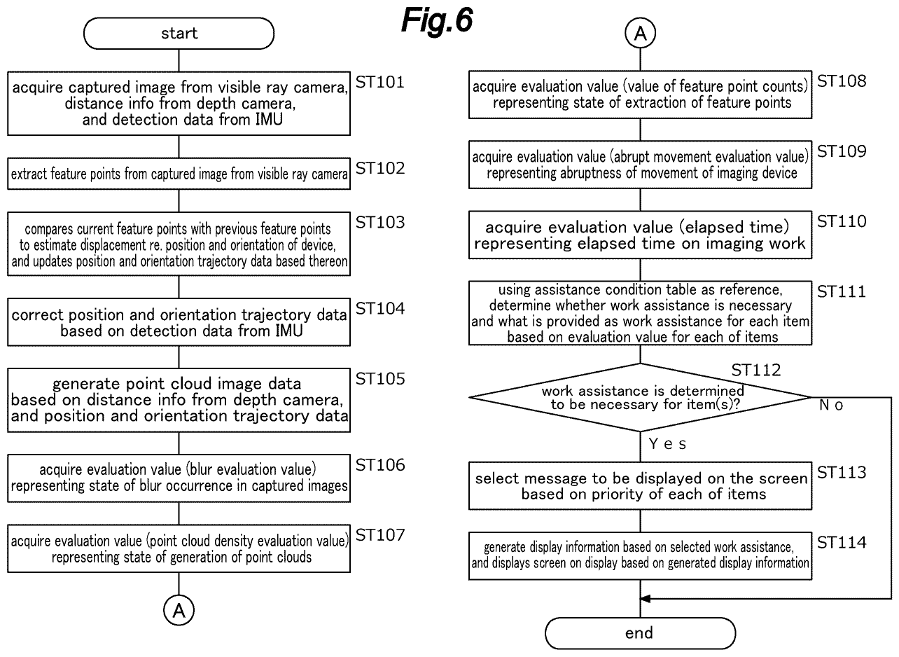

Next, a procedure of operations performed by the processor 16 will be described. FIG. 6 is a flowchart showing a procedure of operations performed by the processor 16.

First, the processor 16 acquires information from the sensor device 12, the information including a captured image from the visible ray camera 21, distance information from the depth camera 22, and detection data from the IMU 23 (ST101).

Next, the processor 16 extracts feature points from the captured image provided from the visible ray camera 21 (feature extraction operation) (ST102).

Next, the processor 16 compares currently extracted feature points with previously extracted feature points to estimate an amount of displacement regarding the position and orientation of the imaging device 1, and then updates the position and orientation trajectory data based on the estimated amount of displacement (tracking operation) (ST103).

Next, the processor 16 corrects the position and orientation trajectory data acquired in the tracking operation based on the detection data provided from the IMU 23 (position and orientation correction operation) (ST104).

Next, the processor 16 generates point cloud image data based on distance information provided from the depth camera 22, and the position and orientation trajectory data acquired in the tracking operation and the position and orientation correction operation (point cloud generation operation) (ST105).

Next, the processor 16 acquires an evaluation value (blur evaluation value) representing a state of blur occurrence in the captured images (blur evaluation operation) (ST106). The blur evaluation value is determined by image analysis of the captured images. In some cases, the blur evaluation value is determined based on the exposure time of the visible ray camera 21 and the detection data provided from the IMU 23

Next, the processor 16 counts point clouds within a target area based on the point cloud image data generated in the point cloud generation operation, thereby acquiring an evaluation value (point cloud density evaluation value) representing a state of generation of point clouds (point cloud density evaluation operation) (ST107).

Next, the processor 16 counts point clouds within a target area based on extraction results in the feature extraction operation, thereby acquiring an evaluation value (value of feature point counts) representing a state of extraction of feature points (feature point evaluation operation) (ST108).

Next, the processor 16 acquires an evaluation value (abrupt movement evaluation value) representing a degree of abruptness of the user's movement of the imaging device 1 (abrupt movement evaluation operation) (ST109). The abrupt movement evaluation value is obtained based on the detection data from the IMU 23. In some cases, the abrupt movement evaluation value is obtained based on an amount of displacement regarding the position and orientation of the imaging device 1 acquired in the tracking operation.

Next, the processor 16 acquires an evaluation value (elapsed time) representing an elapsed time on the imaging work (elapsed time evaluation operation) (ST110). In this operation, the elapsed time is measured from the start of imaging by using a timer.

It should be noted that the order of the processing steps ST106 to ST110 is not limited to that shown in the drawings.

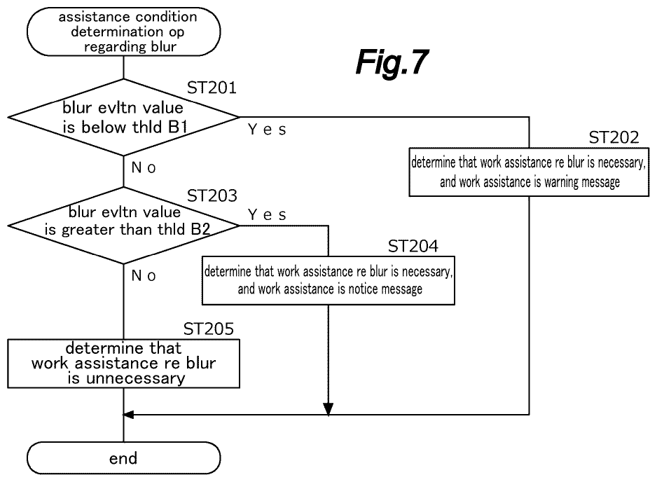

Then, using the assistance condition table (FIG. 2) as a reference, the processor 16 determines, based on the evaluation value for each of items (such as blur, point cloud density, feature point counts, abrupt movement, elapsed time), whether or not work assistance is necessary and what is provided as work assistance for each item (assistance condition determination operation) (ST111). The assistance condition determination operation for determining an assistance condition for each item is shown in FIGS. 7 to 11.

Next, the processor 16 determines whether or not work assistance is determined to be necessary for each of one or more items (ST112).

When determining that work assistance is determined to be necessary for one or more items (Yes at ST112), using the assistance condition table as a reference (FIG. 2), the processor 16 selects, based on the priority of each of items, one or more items for which work assistance is to be provided from among the items for which work assistance is determined to be necessary, and then determines, for each item, what is provided as work assistance; that is, a message (warning message, reminder message, or notice message) to be displayed on the screen (assistance type determination operation) (ST113).

In this case, when determining that work assistance is determined to be necessary for a plurality of items, the processor may provide work assistance (display a message) for all of those items. In some cases, the processor may select only one item with the highest priority, as the item for which work assistance is provided. In other cases, the processor may select a predetermined number of items in descending order of the level of priority, as the items for which work assistance is provided.

Next, based on what work assistance is determined to be provided, the processor 16 generates display information (display information generation operation), and displays a screen on the display 13 based on the generated display information (display operation) (ST114).

Next, an assistance condition determination operation regarding blur; that is, operations for assistance condition determination regarding blur, performed by the processor 16 will be described. FIG. 7 is a flowchart showing a procedure of operations for assistance condition determination regarding blur.

Next, the processor 16, using the assistance condition table as a reference (FIG. 2), the processor 16 determines whether or not work assistance is necessary and what is provided as work assistance regarding blur. The assistance condition table contains a threshold B1 and a threshold B2, entered as determination conditions for a warning message and notice message regarding blur, respectively.

Specifically, first, the processor 16 determines whether or not the blur evaluation value is below the threshold B1 (ST201). When the blur evaluation value is below the threshold B1 (Yes in ST201), the processor 16 determines that work assistance regarding blur is necessary, and that what is provided as work assistance is a warning message (ST202).

When the blur evaluation value is greater than or equal to the threshold B1 (No in ST201), then the processor 16 determines whether or not the blur evaluation value is greater than the threshold B2 (ST203). When the blur evaluation value is greater than the threshold B2 (Yes in ST203), the processor 16 determines that work assistance regarding blur is necessary, and that what is provided as work assistance is a notice message (ST204).

When the blur evaluation value is less than or equal to the threshold B2 (No in ST203), the processor 16 determines that work assistance for blur is unnecessary (ST205).

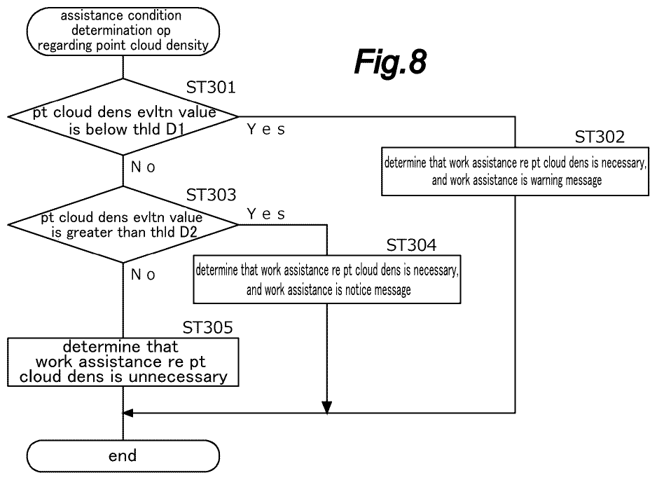

Next, an assistance condition determination operation regarding point cloud density; that is, operations for assistance condition determination regarding point cloud density, performed by the processor 16 will be described. FIG. 8 is a flowchart showing a procedure of operations for assistance condition determination regarding point cloud density.

Next, the processor 16, using the assistance condition table as a reference (FIG. 2), the processor 16 determines whether or not work assistance is necessary and what is provided as work assistance regarding point cloud density. The assistance condition table contains a threshold D1 and a threshold D2, entered as determination conditions for a warning message and notice message regarding point cloud density, respectively.

Specifically, first, the processor 16 determines whether or not the point cloud density evaluation value is below the threshold D1 (ST301). When the point cloud density evaluation value is below the threshold D1 (Yes in ST301), the processor 16 determines that work assistance regarding point cloud density is necessary, and that what is provided as work assistance is a warning message (ST302).

When the point cloud density evaluation value is greater than or equal to the threshold D1 (No in ST301), then the processor 16 determines whether or not the point cloud density evaluation value is greater than the threshold D2 (ST303). When the point cloud density evaluation value is greater than the threshold D2 (Yes in ST303), the processor 16 determines that work assistance regarding point cloud density is necessary, and that what is provided as work assistance is a notice message (ST304).

When the point cloud evaluation value is less than or equal to the threshold D2 (No in ST303), the processor 16 determines that work assistance for point cloud density is unnecessary (ST305).

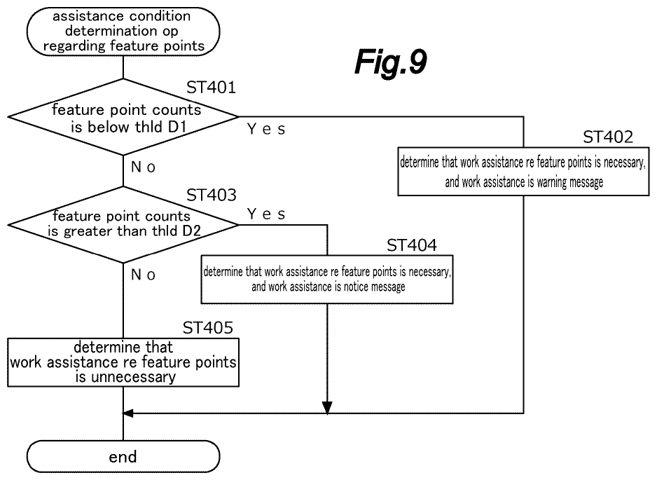

Next, an assistance condition determination operation regarding feature point counts; that is, operations for assistance condition determination regarding feature point counts, performed by the processor 16 will be described. FIG. 9 is a flowchart showing a procedure of operations for assistance condition determination regarding feature point counts.

Next, the processor 16, using the assistance condition table as a reference (FIG. 2), the processor 16 determines whether or not work assistance is necessary and what is provided as work assistance regarding feature point counts. The assistance condition table contains a threshold Q1 and a threshold Q2, entered as determination conditions for a warning message and notice message regarding feature point counts, respectively.

Specifically, first, the processor 16 determines whether or not the value of feature point counts is below the threshold Q1 (ST401). When the value of feature point counts is below the threshold Q1 (Yes in ST401), the processor 16 determines that work assistance regarding feature point counts is necessary, and that what is provided as work assistance is a warning message (ST402).

When the value of feature point counts is greater than or equal to the threshold Q1 (No in ST401), then the processor 16 determines whether or not the value of feature point counts is greater than the threshold Q2 (ST403). When the value of feature point counts is greater than the threshold Q2 (Yes in ST403), the processor 16 determines that work assistance regarding feature point counts is necessary, and that what is provided as work assistance is a notice message (ST404).

When the value of feature point counts is less than or equal to the threshold Q2 (No in ST403), the processor 16 determines that work assistance for feature point counts is unnecessary (ST405).

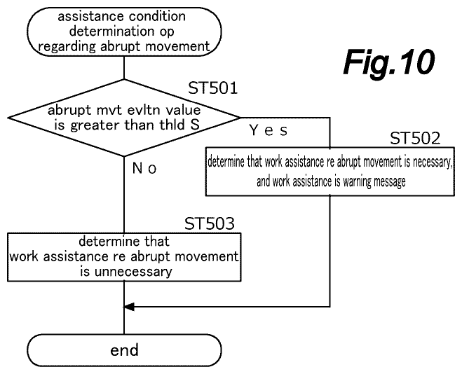

Next, an assistance condition determination operation regarding abrupt movement; that is, operations for assistance condition determination regarding abrupt movement, performed by the processor 16 will be described. FIG. 10 is a flowchart showing a procedure of operations for assistance condition determination regarding abrupt movement.

Next, the processor 16, using the assistance condition table as a reference (FIG. 2), the processor 16 determines whether or not work assistance is necessary and what is provided as work assistance regarding abrupt movement. The assistance condition table contains a threshold S, entered as determination conditions for a warning message and notice message regarding abrupt movement, respectively.

Specifically, first, the processor 16 determines whether or not the abrupt movement evaluation value is greater than the threshold S (ST501). When the abrupt movement evaluation value is greater than the threshold S (Yes in ST501), the processor 16 determines that work assistance regarding abrupt movement is necessary, and that what is provided as work assistance is a warning message (ST502).

When the abrupt movement evaluation value is less than or equal to the threshold S (No in ST501), the processor 16 determines that work assistance for abrupt movement is unnecessary (ST503).

In the present embodiment, when the user moves the imaging device 1 too quickly while shooting, the processor displays a warning message to prompt the user to slow down the movement of the imaging device 1, as work assistance measure. In other cases, when determining the user's movement of the imaging device is too slow based on the abrupt movement evaluation value, the processor may display a notice message to prompt the user to increase the movement of the imaging device 1, as work assistance measure to improve the efficiency of the imaging work.

In this case, a threshold S1 and a threshold S2 may be set as determination conditions for the warning message and the notice message, respectively, so that, when the abrupt movement evaluation value is greater than the threshold S1, the processor can determine that what is provided as work assistance is the warning message, whereas when the abrupt movement evaluation value is less than the threshold S2, the processor can determine that what is provided as work assistance is the notice message.

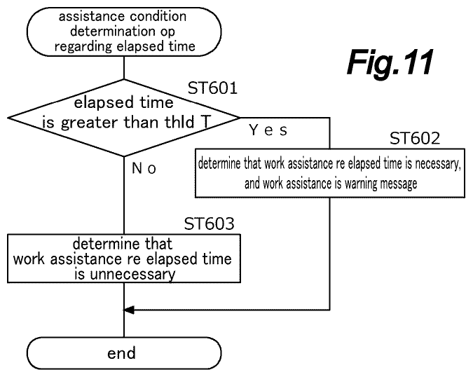

Next, an assistance condition determination operation regarding elapsed time; that is, operations for assistance condition determination regarding elapsed time, performed by the processor 16 will be described. FIG. 11 is a flowchart showing a procedure of operations for assistance condition determination regarding elapsed time.

Next, the processor 16, using the assistance condition table as a reference (FIG. 2), the processor 16 determines whether or not work assistance is necessary and what is provided as work assistance regarding elapsed time. The assistance condition table contains a threshold T, entered as determination conditions for a warning message and notice message regarding elapsed time, respectively.

Specifically, first, the processor 16 determines whether or not the elapsed time evaluation value is greater than the threshold T (ST601). When the elapsed time evaluation value is greater than the threshold T (Yes in ST601), the processor 16 determines that work assistance regarding elapsed time is necessary, and that what is provided as work assistance is a warning message (ST602).

When the elapsed time evaluation value is less than or equal to the threshold T (No in ST601), the processor 16 determines that work assistance for elapsed time is unnecessary (ST603).

Next, an imaging mode screen 101 displayed on the display 13 will be described. FIG. 12 is an explanatory diagram showing an imaging mode screen 101 displayed on the display 13.

The imaging mode screen 101 includes a main window 102 and a sub-window 103. The main window 102 and the sub-window 103 indicate images with different display magnifications; that is, the image being enlarged in the main window 102 and reduced in the sub-window 103.

The main window 102 and sub-window 103 display a captured image 121 and a map image 122, respectively. The captured image 121 is a current captured image; that is, an image captured and output from the visible ray camera 21 in real time. The map image 122 is a bird's-eye point cloud image, i.e., a visualized image (rendered image) indicating spots in the point cloud data as seen from an overhead viewpoint.

The imaging mode screen 101 includes a “start imaging” button 105 and an “end imaging” button 106. When a user operates the “start imaging” button 105, the imaging device 1 starts imaging with the visible ray camera 21 and stores captured images in the memory 15. When a user operates the “end imaging” button 106, the imaging device ends imaging with the visible ray camera 21. When the imaging device is equipped with the depth camera 22 and the IMU 23, the processor acquires distance information from the depth camera 22 and detection data from the IMU 23, in a similar manner to acquiring captured images from the visible ray camera 21.

The imaging mode screen 101 includes a “switch screens” button 107, and a checkbox 108 for indication of the sub-window 103. By operating the “switch screens” button 107, the use can switch the imaging mode screen 101 between (i) a state (shown in FIG. 12) in which the captured image 121 is displayed as an enlarged image in the main window 102 while the map image 122 is displayed as a reduced image in the sub-window 103 and (ii) a state in which the map image 122 is displayed as an enlarged image in the main window 102 while the captured image 121 is displayed as a reduced image in the sub-window 103. By operating the checkbox 108, the user can switch the state of the imaging mode screen 101 between a display state and a non-display state.

The imaging mode screen 101 includes an elapsed time display section 111 and a checkbox 112 for indication of the elapsed time display section 111. The elapsed time display section 111 shows the lapsed time from the start of imaging. By checking the checkbox 112, the user can switch the display state of the time display section 111 between on and off states.

In this example, the elapsed time display section 111 displays the elapsed time measured from the start of imaging. However, instead of or in addition to the elapsed time, the elapsed time display section 111 may display a remaining time before an upper time limit is reached. In other cases, the elapsed time display section 111 may display a ratio of the elapsed time from the start to the remaining time before the upper limit time is reached, as a state of elapsed time. In this case, the elapsed time display section 111 may display an image representing the state of elapsed time, such as a level indicator which changes with time.

The imaging mode screen 101 includes an “imaging” tab 131 and a “setting” tab 132. By operating the tabs 131 and 132, the user can switch the operating mode between the imaging mode and the setting mode. The imaging mode screen 101 shown in FIG. 12 is displayed when the user operates the “imaging” tab 131. When the user operates the “setting” tab 132, the screen transitions to a setting mode screen 201 (FIG. 15).

In the present embodiment, the imaging mode and setting mode are switched by operating the tabs 131 and 132. However, in other embodiments, the imaging mode and setting mode may be switched by any other type of entry element, such as a button.

Next, how a warning message, a reminder message, and a notice message are indicated on the screen will be described. FIG. 13 is an explanatory diagram showing how a warning message is indicated on the imaging mode screen 101. FIG. 14 is an explanatory diagram showing how a notice message is indicated on the imaging mode screen 101.

As shown in FIG. 13, when determining that work assistance is necessary and that work assistance is to provide a warning message, a first message display window 141 including the warning message is overlaid onto the imaging mode screen 101 in the center part thereof.

The example shown in FIG. 13 shows a case when the work assistance is to provide a warning message regarding blur, and the message describes “blur occurring (slow down movement of device).”

When the work assistance is to provide a warning message regarding point cloud density, the first message display window 141 including a warning message “point cloud density reduced (slow down movement of device)” is displayed in the center of the screen. When the work assistance is to provide a warning message regarding point cloud density, the first message display window 141 including a warning message “feature point counts reduced (turn device to distinctive pattern or objects)” is displayed in the center of the screen. When the work assistance is to provide a warning message regarding point cloud density, the first message display window 141 including a warning message “feature point counts reduced (turn device to distinctive pattern or objects)” is displayed in the center of the screen.

The first message display window 141 remains displayed until a state of the user's imaging work is improved, and disappears once the state of the user's imaging work is improved.

As shown in FIG. 14, when determining that work assistance is necessary and that work assistance is to provide a notice message, a second message display window 142 including the notice message is overlaid onto the imaging mode screen 101 in the lower part thereof. The example shown in FIG. 14 shows a case when the work assistance is to provide a notice message regarding any one of blur, point cloud density, feature point counts, and the message describes “imaging well (faster movement allowed).”

When the work assistance is to provide a reminder message regarding elapsed time, the second message display window 142 including the reminder message “shooting time approaches upper limit time” is overlaid onto the imaging mode screen 101 in the lower part thereof.

The second message display window 142 remains displayed until a state of the user's imaging work state is improved, and disappears once the state of the user's imaging work is improved. In some cases, the second message display window 142 may display, in addition to a notice message as work assistance, information useful for the user's imaging work or information to alert the user.

In this way, in the present embodiment, a warning message regarding any of the items, blur, point cloud density, feature point count, and abrupt movement is displayed in the center part of the screen 101 (FIG. 13). This configuration enables clear indication of a point requiring immediate improvement in the user's imaging work to the user conducting their imaging work. In particular, the warning message provides, for each item, work assistance in the text form that describes a point requiring improvement along with their state and causes, thereby enabling the user to immediately recognize the point requiring improvement in their imaging work.

Moreover, a notice message regarding any of the items, blur, point cloud density, and feature point count is displayed in the lower part of the screen 101 (FIG. 14). When a user's imaging work is good but can be further improved, this configuration enables clear indication of a manner in which imaging can be desirably done. In particular, similarly to the warning message, the notice message provides work assistance in the text form that describes a point requiring improvement along with their state and causes, thereby enabling the user to immediately recognize the point requiring improvement in their imaging work.

In addition, a reminder message regarding elapsed time is displayed in the lower part of the screen 101 (FIG. 14). This configuration enables the user conducting imaging work to be alerted to the elapsed time, which is an important consideration for their imaging work.

In the present embodiment, warning messages, reminder messages, and notice messages are displayed on the screen 101 as work assistance. However, work assistance is not limited to messages displayed on the screen 101. For example, what are displayed on the screen 101 may be images (such as icons, symbols, change in color, and animations) representing matters that serve as similar work assistance to warning messages, reminder messages, and notice messages. In some cases, the imaging device 1 may be equipped with a lamp and provide work assistance by changing the color of the lamp or blinking to represent matters that serve as similar work assistance to warning messages, reminder messages, and notice messages. In other cases, the imaging device 1 may be equipped with a speaker and provide work assistance by producing sounds or voice messages from the speaker to represent matters that serve as similar work assistance to warning messages, reminder messages, and notice messages.

Next, a setting mode screen 201 (customization screen) displayed on the display 13 will be described. FIG. 15 is an explanatory diagram showing the setting mode screen 201.

The setting mode screen 201 displays a first setting entry section 211 for settings of warning messages, a second setting entry section 212 for settings of reminder messages, and a third setting entry section 213 for settings of notice messages.

The first setting entry section 211 includes a checkbox 231 for settings of warning messages. By operating the checkbox 231, the user can toggle the enablement or disablement of all the items regarding warning messages collectively. The first setting entry section 211 includes checkboxes 232, each for a corresponding one of the items (blur, point cloud density, feature point counts, and abrupt movement). By operating the checkboxes 232, the user can individually enable or disable processing operations for each item. The first setting entry section 211 includes threshold entry fields 233, each for a corresponding one of the items. The user can enter a value representing a threshold for each item into the threshold entry field 233.

The second setting entry section 212 includes a checkbox 241 for settings of reminder messages. By operating the checkbox 241, the user can toggle the enablement or disablement of all the items regarding reminder messages collectively. The second setting entry section 212 includes checkboxes 242, each for a corresponding one of the items (elapsed time). By operating the checkboxes 242, the user can individually enable or disable processing operations for each item. The second setting entry section 212 includes threshold entry fields 243, each for a corresponding one of the items. The user can enter a value representing a threshold for each item into the threshold entry field 243. Although FIG. 15 shows the example, which allows for settings for only one item (elapsed time) for reminder messages, the second setting entry section may be configured to allow for settings for two or more items for reminder messages.

The third setting entry section 213 includes a checkbox 251 for settings of notice messages. By operating the checkbox 251, the user can toggle the enablement or disablement of all the items regarding notice messages collectively. The third setting entry section 213 includes checkboxes 252, each for a corresponding one of the items (blur, point cloud density, and feature point counts). By operating the checkboxes 252, the user can individually enable or disable processing operations for each item. The third setting entry section 213 includes threshold entry fields 253, each for a corresponding one of the items. The user can enter a value representing a threshold for each item into the threshold entry field 253.

In this example, values representing thresholds can be entered into the entry fields 233, 243, and 253 as the entry section for entry of determination conditions. However, the setting entry section may be configured to include slide bars or buttons that allow the user to adjust the levels of determination criteria.

The setting mode screen 201 includes a “save settings” button 261 and a “load settings” button 262. When the user operates the “save settings” button 261, setting information is saved with current entries. When the user operates the “load settings” button 262, the previous setting information is loaded and displayed in the setting entry sections 211, 212, and 213.

In the present embodiment, the user can designate, for each item, a determination condition (threshold) for determining whether work assistance is necessary therefor. Thus, the user can enter appropriate thresholds based on the characteristics of a measurement target site. For example, when the measurement target site is a large space and few subjects exist within the distance where point clouds can be generated, point clouds are difficult to be created, which means that the point cloud density evaluation value may frequently fall below the threshold, potentially causing frequent warning messages. In this case, when finding the frequent warning messages bothersome, the user can reset the threshold to a lower value to avoid the frequent warning messages.

The proper state of enablement and disablement of each item and the determination conditions (thresholds) therefor differ depending on the measurement target site. Thus, the imaging device may be configured such that setting information can be preset for each type of measurement target site, and the appropriate setting information for the measurement target site can be loaded when starting imaging work. This configuration reduces the amount of work for entry of settings required when starting imaging work. Furthermore, the imaging device may be configured such that the user's customized settings are saved in association with information on the measurement target site at the end of imaging work, which enables a quick start of imaging work on the same measurement site next time by the loading of the same settings.

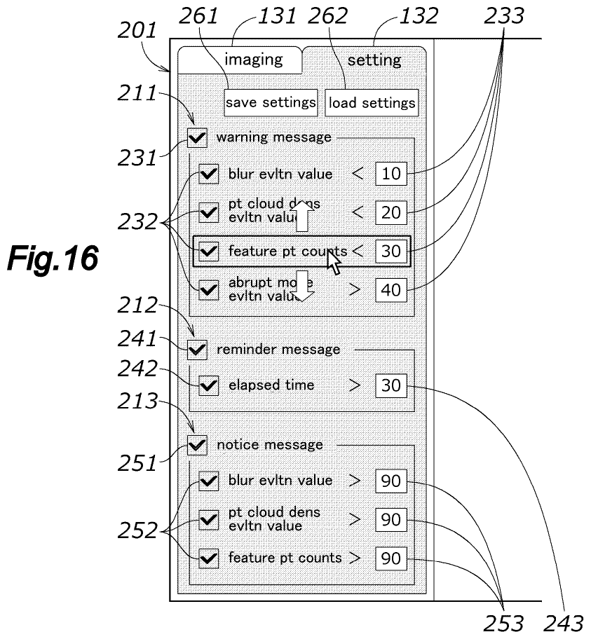

Next, how levels of priority are changed on the setting mode screen 201 for item by item will be described. FIG. 16 is an explanatory diagram showing how levels of priority are changed for item by item.

In the first setting entry section 211, a plurality of items (blur, point cloud density, feature point counts, and abrupt movement) are displayed in descending order of priority from the top. In the third setting entry section 213, a plurality of items (blur, point cloud density, and feature point counts) are also displayed in descending order of priority from the top. In the example shown in FIG. 15, only one item (elapsed time) is displayed in the second setting entry section 212. However, in the case where a plurality of items are displayed in the second setting entry section, those items are arranged from top to bottom in descending order of priority from the top.

In the setting entry sections 211, 212, and 213 (entry section), the user can change the priority for any of the items by performing a certain operation. For example, when the user performs a drag-and-drop operation on the entry section for an item in each of the setting entry sections 211, 212, and 213 to reorder the entry sections for the items, the order of priority is changed so as to conform to the reordered entry sections for the items.

Operations for work assistance based on the level of priority are performed when a plurality of items that are enabled by ticking the corresponding checkboxes 231, 241, and 251. Specifically, for each of the enabled items, the processor determines, based on the level of priority, what is provided as work assistance; that is, a message (warning message, reminder message, or notice message) to be displayed on the screen.

The setting entry sections 211, 212, and 213 may include priority entry fields where the user can enter values indicating priority.

It is unlikely that warning messages and notice messages are displayed simultaneously. However, warning messages and reminder messages can appear simultaneously, and notice messages and reminder messages can also appear together. In this case, when messages that are displayed simultaneously are types of messages displayed at different positions (e.g., center and bottom parts of the screen), the messages can be displayed as they are. However, when simultaneously displayed messages are to be displayed at the same position (e.g., both at the bottom part of the screen), the messages may be displayed such that one of the messages is displayed in priority to the other, or displayed alternatively.

While specific embodiments of the present disclosure are described herein for illustrative purposes, the present disclosure is not limited to those specific embodiments. Various changes, substitutions, additions, and omissions may be made to elements and features of these embodiments. Moreover, elements and features of the different embodiments may be combined with each other to yield another embodiment of the present disclosure.

### Industrial Applicability

An imaging device, an imaging work assistance method and an imaging work assistance program according to the present disclosure, can clearly indicate, to a user conducting imaging work, a point requiring immediate improvement in the imaging work, and are useful as an imaging device for imaging spots in a measurement target site, thereby allowing a 3D measurement operation to be performed for generating 3D space information on the measurement target site based on captured images of the spots therein, as well as an imaging work assistance method and an imaging work assistance program for assisting a user to conduct imaging work using the imaging device.

### GLOSSARY

1 imaging device
11 imaging device body
12 sensor device
13 display
14 input device
15 memory
16 processor
21 visible ray camera
22 depth camera
23 IMU
101 imaging mode screen
111 elapsed time display section
121 captured image
122 map image
141 first message display window
142 second message display window
201 setting mode screen
211 first setting entry section
212 second setting entry section
213 third setting entry section
P1 3D measurement operation
P2 work assistance operation
P3 display information generation operation
P4 display operation
P11 feature extraction operation
P12 tracking operation
P13 position and orientation correction operation
P14 point cloud generation operation
P21 blur evaluation operation
P22 point cloud density evaluation operation
P23 feature point evaluation operation
P24 abrupt movement evaluation operation
P25 elapsed time evaluation operation
P26 assistance condition determination operation
P27 assistance type determination operation

1. An imaging device for imaging a measurement target site, thereby allowing a 3D measurement operation to be performed for generating 3D space information on the measurement target site based on captured images thereof, the imaging device comprising:
an imaging device body held by a user;
an imaging module provided in the imaging device body to image the measurement target site;
a display device for displaying work assistance information regarding imaging work in which the user causes the imaging module to image the measurement target site while moving therein with holding the imaging device body; and
a processor for controlling the imaging module and the display device,
wherein the processor performs operations including:
determining, based on states of the captured images, whether or not work assistance that improves a state of the user's imaging work is necessary; and
when determining that work assistance is necessary, displaying work assistance information on the display device, the work assistance information prompting the user to take action for improvement of the user's imaging work.

2. The imaging device as claimed in claim 1, wherein the processor determines whether or not work assistance is necessary based on a state of blur occurrence in the captured images.

3. The imaging device as claimed in claim 2, wherein the processor determines whether or not work assistance is necessary based on a result of image analysis on the captured images.

4. The imaging device as claimed in claim 2, further comprising a detector for detecting a state of motion of the imaging device,
wherein the processor determines whether or not work assistance is necessary based on at least one of an exposure time used by the imaging module and a detection result provided from the detector.

5. The imaging device as claimed in claim 1, wherein the processor determines whether or not work assistance is necessary based on a state of generation of point clouds generated as measurement results in the 3D measurement operation.

6. The imaging device as claimed in claim 1, wherein the processor determines whether or not work assistance is necessary based on a state of extraction of feature points extracted from the captured images in the 3D measurement operation.

7. The imaging device as claimed in claim 1, wherein, using a table as a reference, the table containing a plurality of items for each of which a determination condition is entered, the processor determines whether or not work assistance is necessary on an item-by-item basis.

8.-9. (canceled)

10. An imaging device for imaging a measurement target site, thereby allowing a 3D measurement operation to be performed for generating 3D space information on the measurement target site based on captured images thereof, the imaging device comprising:
an imaging device body held by a user;
an imaging module provided in the imaging device body to image the measurement target site;
a display device for displaying work assistance information regarding imaging work in which the user causes the imaging module to image the measurement target site while moving therein with holding the imaging device body; and
a processor for controlling the imaging module and the display device,
wherein the processor performs operations including:
determining, based on a state of the user's imaging work, whether or not work assistance that improves the state of the user's imaging work is necessary; and
when determining that work assistance is necessary, displaying work assistance information on the display device, the work assistance information prompting the user to take action for improvement of the user's imaging work.

11. The imaging device as claimed in claim 10, wherein the processor determines whether or not work assistance is necessary based on a degree of abruptness with which the user moves the imaging device.

12. The imaging device as claimed in claim 11, further comprising a detector for detecting a state of motion of the imaging device,
wherein the processor determines whether or not work assistance is necessary based on a detection result provided from the detector.

13. The imaging device as claimed in claim 11, wherein the processor determines whether or not work assistance is necessary based on a change in a position and orientation of the imaging device itself acquired in the 3D measurement operation.

14. The imaging device as claimed in claim 10, wherein the processor measures an elapsed time from the start of imaging and determines whether work assistance is necessary based on a result of the measurement.

15. The imaging device as claimed in claim 10, wherein the processor measures an elapsed time from the start of imaging and displays information regarding the elapsed time on the imaging work on the display device.

16. The imaging device as claimed in claim 10, wherein, using a table as a reference, the table containing a plurality of items for each of which a determination condition is entered, the processor determines whether or not work assistance is necessary on an item-by-item basis.

17.-29. (canceled)

30. An imaging device for imaging a measurement target site, thereby allowing a 3D measurement operation to be performed for generating 3D space information on the measurement target site based on captured images thereof, the imaging device comprising:
an imaging device body held by a user;
an imaging module provided in the imaging device body to image the measurement target site;
a display device for displaying work assistance information regarding imaging work in which the user causes the imaging module to image the measurement target site while moving therein with holding the imaging device body; and
a processor for controlling the imaging module and the display device,
wherein the processor performs operations including:
displaying a customization screen on the display device, the customization screen including an entry section that enables the user to select at least one of a plurality of items, for which subsequent operations are performed,
for the at least one item selected by the user through the customization screen, determining whether or not work assistance is necessary and also determining what is provided as work assistance,
when determining that work assistance is necessary, performing a work assistance operation that includes displaying work assistance information on the display device.

31. The imaging device as claimed in claim 30, wherein the processor displays the customization screen on the display device, the customization screen including an entry section that enables the user to individually enable or disable operations for the plurality of items on an item-by-item basis, related to the work assistance information that prompts the user to take action for improvement of the user's imaging work.

32. The imaging device as claimed in claim 30, wherein the processor displays the customization screen on the display device, the customization screen including an entry section that enables the user to individually enable or disable operations for the plurality of items on an item-by-item basis, related to the work assistance information that prompts the user to take action for enhancement of the user's imaging work.

33. The imaging device as claimed in claim 30, wherein the processor displays the customization screen on the display device, the customization screen including an entry section that enables the user to instruct the imaging device to store setting information acquired through the user's operation on the customization screen, and read the stored setting information.

34. The imaging device as claimed in claim 30, wherein the processor displays the customization screen on the display device, the customization screen including an entry section that enables the user to enter a determination condition that can be used to determine whether or not work assistance to the user is necessary.

35. The imaging device as claimed in claim 30, wherein the processor displays the customization screen on the display device, the customization screen including an entry section that enables the user to designate levels of priority with which the work assistance operations are performed, for the plurality of items on an item-by-item basis, based on determination results indicating the necessity of work assistance for the plurality of items.

36.-37. (canceled)
